(19) United States
(12) Patent Application Publication
(10) Pub. No.: US 2026/0198579 A1
(43) Pub. Date: Jul. 16, 2026

(54) AEROSOL GENERATION SYSTEM, CONTROL METHOD AND NON-TRANSITORY COMPUTER READABLE MEDIUM

(71) Applicant: Japan Tobacco Inc., Tokyo (JP)

(72) Inventors: Yasunobu INOUE, Tokyo (JP); Manabu YAMADA, Tokyo (JP)

(73) Assignee: Japan Tobacco Inc., Tokyo (JP)

(21) Appl. No.: 19/127,747

(22) PCT Filed: Nov. 16, 2022
(86) PCT No.: PCT/JP2022/042598

§ 371 Date: May 7, 2025

(51) Int. Cl. A24F 40/46; A24F 40/20; A24F 40/57

(52) U.S. Cl. CPC A24F 40/46; A24F 40/57; A24F 40/20

(57) ABSTRACT

An aerosol generation system including a tubular body that accommodates a substrate containing an aerosol source, resistive heating layers that are laminated onto the outer side of a side wall of the tubular body, and electrically conductive layers that are laminated so as to overlap at least portions of the resistive heating layers.

### TECHNICAL FIELD

The present disclosure relates to an aerosol generation system, a control method and a program.

### BACKGROUND ART

Inhalation devices that generate substances to be inhaled by a user, such as e-cigarettes and nebulizers, are in widespread use. For example, an inhalation device employs an aerosol source for generating an aerosol, and a substrate including a flavor source or the like for imparting a flavor component to the generated aerosol, to generate an aerosol to which the flavor component has been imparted. The user can enjoy the flavor by inhaling the aerosol to which the flavor component has been imparted, generated by the inhalation device. The action by which the user inhales the aerosol is also referred to below as “puffing” or a “puffing action”.

There is a demand for improved heating efficiency in inhalation devices of a type in which an aerosol is generated by heating a substrate. For example, patent literature article 1 listed below discloses a technique in which a coating of an electrically insulating material is formed on the surface of a heating chamber having an opening portion for accepting a substrate, and a coating of an electrically conductive material that acts as a Joule heater is additionally formed on the electrically insulating material.

### CITATION LIST

### Patent Literature

PTL 1 WO 2022/167261 A1

### SUMMARY OF INVENTION

### Technical Problem

However, the technique disclosed in patent literature article 1 has only recently been developed, and there is still room for improvement in various aspects.

Accordingly, the present disclosure takes account of the abovementioned problems, and the objective of the present disclosure is to provide a mechanism capable of further improving the quality of a user experience.

### Solution to Problem

In order to solve the above problem, one aspect of the present invention provides an aerosol generation system comprising a tubular body that accommodates a substrate containing an aerosol source, resistive heating layers that are laminated onto the outer side of a side wall of the tubular body, and electrically conductive layers that are laminated so as to overlap at least portions of the resistive heating layers.

The rate of variation, with respect to temperature, in the temperature coefficient of resistance of the electrically conductive layers may be less than the rate of variation, with respect to temperature, in the temperature coefficient of resistance of the resistive heating layers.

The electrically conductive layers may be made of a single metal, and the resistive heating layers may be made of an alloy.

The resistive heating layers may have a first part that generates heat when a current flows and a second part that generates less heat than the first part, and the electrically conductive layers may be laminated so as to overlap at least portions of the first parts of the resistive heating layers.

Conducting wires connected to a power source unit that applies a voltage to the electrically conductive layers may be connected to parts of the electrically conductive layers that do not overlap the first part.

The direction in which a current flows in the resistive heating layers and the direction in which a current flows in the parts of the electrically conductive layers that overlap the resistive heating layers may coincide.

The aerosol generation system may further comprise a control unit that controls the supply of power to the resistive heating layers on the basis of an electrical resistance value of the electrically conductive layers.

The control unit may repeat, in the stated order, a first step for applying a voltage to the electrically conductive layers to measure an electrical resistance value of the electrically conductive layers, and a second step for applying a voltage to the resistive heating layers in a manner determined on the basis of the electrical resistance value of the electrically conductive layers measured in the first step.

The control unit may cause a period during which the first step is performed and a period during which the second step is performed to differ.

The control unit may control the manner in which the voltage is applied to the resistive heating layers on the basis of control information defining a time series transition of a target value of a parameter corresponding to the temperature of the resistive heating layers.

The period during which the supply of power to the resistive heating layers is controlled on the basis of the control information may include, in the stated order: a first period during which the temperature of the resistive heating layers increases from an initial temperature or is maintained; a second period, following the first period, during which the temperature of the resistive heating layers decreases or is maintained; and a third period, following the second period, during which the temperature of the resistive heating layers increases or is maintained.

The period during which the supply of power to the resistive heating layers is controlled on the basis of the control information may include, in the stated order: a first period during which the temperature of the resistive heating layers increases from an initial temperature or is maintained; a second period, following the first period, during which the temperature of the resistive heating layers decreases; and a third period, following the second period, during which the temperature of the resistive heating layers increases or is maintained.

The aerosol generation system may further comprise the substrate.

In addition, in order to solve the above problem, another aspect of the present invention provides a control method executed by a computer that controls an aerosol generation system, wherein the aerosol generation system comprises a tubular body that accommodates a substrate containing an aerosol source, resistive heating layers that are laminated onto the outer side of a side wall of the tubular body, and electrically conductive layers that are laminated so as to overlap at least portions of the resistive heating layers, and the control method includes controlling the supply of electric power to the resistive heating layers on the basis of an electrical resistance value of the electrically conductive layers.

In addition, in order to solve the above problem, another aspect of the invention provides a program executed by a computer that controls an aerosol generation system, wherein the aerosol generation system comprises a tubular body that accommodates a substrate containing an aerosol source, resistive heating layers that are laminated onto the outer side of a side wall of the tubular body, and electrically conductive layers that are laminated so as to overlap at least portions of the resistive heating layers, and the program causes the computer to function as a control unit that controls the supply of electric power to the resistive heating layers on the basis of an electrical resistance value of the electrically conductive layers.

### Advantageous Effects of Invention

The present disclosure as described above provides a mechanism capable of further improving the quality of a user experience.

### BRIEF DESCRIPTION OF DRAWINGS

FIG. 1 is a schematic diagram illustrating schematically a configuration example of an inhalation device.

FIG. 2 is an oblique view of an example of a heating system of an inhalation device according to an embodiment.

FIG. 3 is an oblique view of an accommodating portion illustrated in FIG. 2.

FIG. 4 is a cross-sectional view of the accommodating portion taken along the line 4-4 illustrated in FIG. 3.

FIG. 5 is a cross-sectional view of the accommodating portion taken along the line 5-5 illustrated in FIG. 4.

FIG. 6 is a longitudinal cross-sectional view of an accommodating portion including non-pressing portions, in a state in which a stick-shaped substrate is held in a holding portion.

FIG. 7 is a longitudinal cross-sectional view of an accommodating portion including pressing portions, in a state in which a stick-shaped substrate is held in a holding portion.

FIG. 8 is a cross-sectional view of the accommodating portion taken along the line 7-7 illustrated in FIG. 7.

FIG. 9 is a diagram illustrating an example of the steps for manufacturing the heating system according to the embodiment.

FIG. 10 is a diagram illustrating an example of the steps for manufacturing the heating system according to the embodiment.

FIG. 11 is a diagram illustrating an example of the steps for manufacturing the heating system according to a modified example.

FIG. 12 is a diagram illustrating an example of the steps for manufacturing the heating system according to the modified example.

FIG. 13 is a diagram illustrating an example of the steps for manufacturing the heating system according to the modified example.

FIG. 14 is a diagram illustrating an example of the steps for manufacturing the heating system according to the modified example.

FIG. 15 is a diagram illustrating an example of the steps for manufacturing the heating system according to the modified example.

FIG. 16 is a graph illustrating an example of the transition in the temperature of heating units 40 when temperature control is performed on the basis of the heating profile shown in Table 1.

FIG. 17 is a graph illustrating an example of the transition in temperature of the heating units 40 when temperature control is performed on the basis of the heating profile shown in Table 2.

FIG. 18 is a graph used to describe the temperature control of the resistive heating layers according to the present embodiment.

FIG. 19 is a flowchart illustrating an example of a processing flow executed in the inhalation device according to the present embodiment.

### DESCRIPTION OF EMBODIMENTS

Preferred embodiments of the present disclosure will now be described in detail with reference to the accompanying drawings. It should be noted that in the specification and the drawings, duplicate descriptions are omitted by using the same reference signs to denote constituent elements having substantially the same functional configuration.

In this specification and the drawings, elements having substantially identical functional configurations may also be distinguished by using the same code followed by an index comprising different alphabetic or numeric characters. For example, a plurality of elements having a substantially identical functional configuration are distinguished, as necessary, as devices 1-1, 1-2, and 1-3. However, if there is no need to specifically distinguish between each of the plurality of elements having a substantially identical functional configuration, only the same code is assigned. For example, devices 1-1, 1-2, and 1-3 are also simply referred to as device 1 when there is no need to distinguish between devices 1-1, 1-2, and 1-3.

### <1. Example Configuration of Inhalation Device>

An inhalation device is a device for generating a substance to be inhaled by a user. Hereinafter, the substance generated by the inhalation device will be described as being an aerosol. Alternatively, the substance generated by the inhalation device may be a gas.

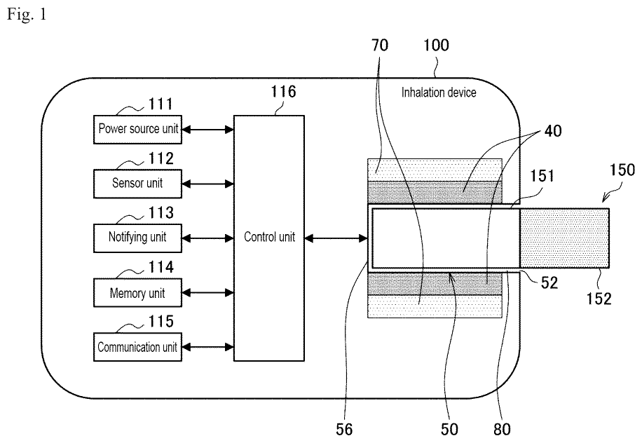

FIG. 1 is a schematic diagram illustrating schematically a configuration example of an inhalation device. As illustrated in FIG. 1, an inhalation device 100 according to the present configuration example comprises a power source unit 111, a sensor unit 112, a notifying unit 113, a memory unit 114, a communication unit 115, a control unit 116, heating units 40, an accommodating unit 50, and a heat insulating portion 70.

The power source unit 111 stores electric power. The power source unit 111 then supplies the electric power to each component of the inhalation device 100 in accordance with control performed by the control unit 116. The power source unit 111 may be configured, for example, by a rechargeable battery such as a lithium ion secondary battery.

The sensor unit 112 acquires various types of information relating to the inhalation device 100. As an example, the sensor unit 112 is configured by a pressure sensor such as a condenser microphone, a flow rate sensor or a temperature sensor, etc., and acquires values associated with inhalation by a user. As another example, the sensor unit 112 is configured by an input device, such as a button or switch, for accepting input of information from the user.

The notification unit 113 notifies the user of the information. The notification unit 113 is configured by a light emitting device that emits light, a display device that displays images, a sound output device that outputs sound, or a vibrating device that vibrates, for example.

The memory unit 114 stores various types of information for the operation of the inhalation device 100. The memory unit 114 is configured by a non-volatile storage medium such as a flash memory, for example.

The communication unit 115 is a communication interface capable of performing communication conforming to any wired or wireless communication standard. Examples of communication standards that may be used include standards that employ Wi-Fi (registered trademark), Bluetooth (registered trademark), Bluetooth Low Energy (BLE) (registered trademark), Near-Field Communication (NFC), or Low Power Wide Area (LPWA), for example.

The control unit 116 functions as an arithmetic processing device and a control device, and controls overall operation within the inhalation device 100 in accordance with various programs. The control unit 116 is realized by a Central Processing Unit (CPU) or an electronic circuit such as a microprocessor, for example.

The accommodating portion 50 has an internal space 80, and holds a stick-shaped substrate 150 while accommodating a portion of the stick-shaped substrate 150 in the internal space 80. The accommodating portion 50 has an opening 52 allowing the internal space 80 to communicate with the outside, and accommodates the stick-shaped substrate 150 that has been inserted into the internal space 80 from the opening 52. For example, the accommodating portion 50 is a tubular body including the opening 52 and having a bottom wall 56 serving as a bottom surface, and defines the columnar internal space 80. An air flow path for supplying air to the internal space 80 may be connected to the accommodating portion 50. An air inflow hole, which is an inlet for air into the air flow path, is disposed in a side surface of the inhalation device 100, for example. An air outflow hole, which is an outlet for air from the air flow path to the internal space 80, is disposed in the bottom wall 56, for example.

The stick-shaped substrate 150 comprises a substrate portion 151 and a mouthpiece portion 152. The substrate portion 151 includes an aerosol source. The aerosol source includes a tobacco-derived or non-tobacco-derived flavor component. If the inhalation device 100 is a medical inhaler such as a nebulizer, the aerosol source may include a drug. The aerosol source may, for example, be a liquid such as water or a polyhydric alcohol, for example glycerol or propylene glycol, containing the tobacco-derived or non-tobacco-derived flavor component, or may be a solid including the tobacco-derived or non-tobacco-derived flavor component. In a state in which the stick-shaped substrate 150 is being held in the accommodating portion 50, at least a portion of the substrate portion 151 is accommodated in the internal space 80, and at least a portion of the mouthpiece portion 152 protrudes from the opening 52. Then, when the user holds the mouthpiece portion 152 protruding from the opening 52 in their mouth and inhales, air flows into the internal space 80 via the air flow path, which is not illustrated in the drawings, and reaches the inside of the user's mouth together with the aerosol generated from the substrate portion 151.

The heating units 40 heat the aerosol source to atomize the aerosol source, thereby generating the aerosol. In the example illustrated in FIG. 1, the heating units 40 are configured in a film shape and are disposed so as to cover the outer periphery of the accommodating portion 50. Then, when the heating units 40 generate heat, the substrate portion 151 of the stick-shaped substrate 150 is heated from the outer periphery, generating the aerosol. The heating units 40 generate heat when supplied with electricity from the power source unit 111. By way of example, electricity may be supplied when the sensor unit 112 detects that the user has started inhaling and/or that predetermined information has been input. The supply of electricity may then be stopped when the sensor unit 112 detects that the user has finished inhaling and/or that predetermined information has been input.

The heat insulating portion 70 prevents heat transfer from the heating units 40 to other components. For example, the heat insulating portion 70 is configured from a vacuum heat insulating material or an aerogel heat insulating material, or the like.

A configuration example of the inhalation device 100 has been described above. The inhalation device 100 is, of course, not limited to the configuration described above, and may adopt various configurations, such as those illustrated below by way of example.

As an example, the accommodating portion 50 may include an opening and closing mechanism such as a hinge for opening and closing a portion of an outer shell that forms the internal space 80. Then, by opening and closing the outer shell, the accommodating portion 50 may clamp and accommodate the stick-shaped substrate 150 that has been inserted into the internal space 80. In this case, the heating units 40 may be provided on the clamping part of the accommodating portion 50, and may heat the stick-shaped substrate 150 while pressing the same.

Furthermore, the accommodating portion 50 may have a so-called counterflow air intake and exhaust configuration. In this case, air flows into the internal space 80 through the opening 52 as the user puffs. The air that has flowed in then passes through the interior of the stick-shaped substrate 150 from the tip of the stick-shaped substrate 150 and reaches the inside of the user's mouth together with the aerosol.

The stick-shaped substrate 150 is an example of an aerosol generating substrate that contains an aerosol source. The inhalation device 100 and the stick-shaped substrate 150 cooperate to generate an aerosol to be inhaled by the user. As such, the combination of the inhalation device 100 and the stick-shaped substrate 150 may be considered to be an aerosol generation system.

### <2. Technical Features>

### <2. 1. Basic Configuration>

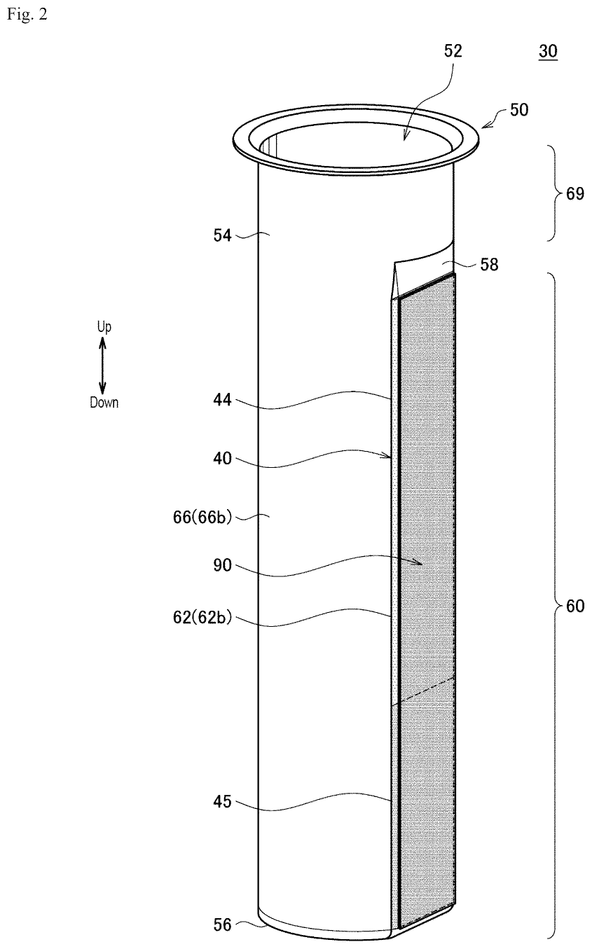

The basic configuration of the inhalation device 100 according to the present embodiment, as relates to the heating of the stick-shaped substrate 150, will now be described with reference to FIG. 2 to FIG. 8.

FIG. 2 is an oblique view of an example of a heating system 30 of the inhalation device 100 according to the present embodiment. The heating system 30 is a system of components involved in heating the stick-shaped substrate 150. The heating system 30 illustrated in FIG. 2 comprises the heating units 40, the accommodating portion 50, and measuring units 90. Besides the heating units 40, the accommodating portion 50 and the measuring units 90 illustrated in FIG. 2, the heating system 30 also includes the heat insulating portion 70 illustrated in FIG. 1. As illustrated in FIG. 2, the heating units 40 are disposed on the outer side of the accommodating portion 50. Therefore, when the heating units 40 generate heat, the accommodating portion 50 is heated from the outside and the stick-shaped substrate 150 is heated by heat transfer from the accommodating portion 50. This allows an aerosol to be generated from the stick-shaped substrate 150. Furthermore, the measuring units 90 are disposed on the outer side of the heating units 40 in close contact with the heating units 40. The measuring units 90 are consequently capable of accurately measuring the temperature of the heating units 40.

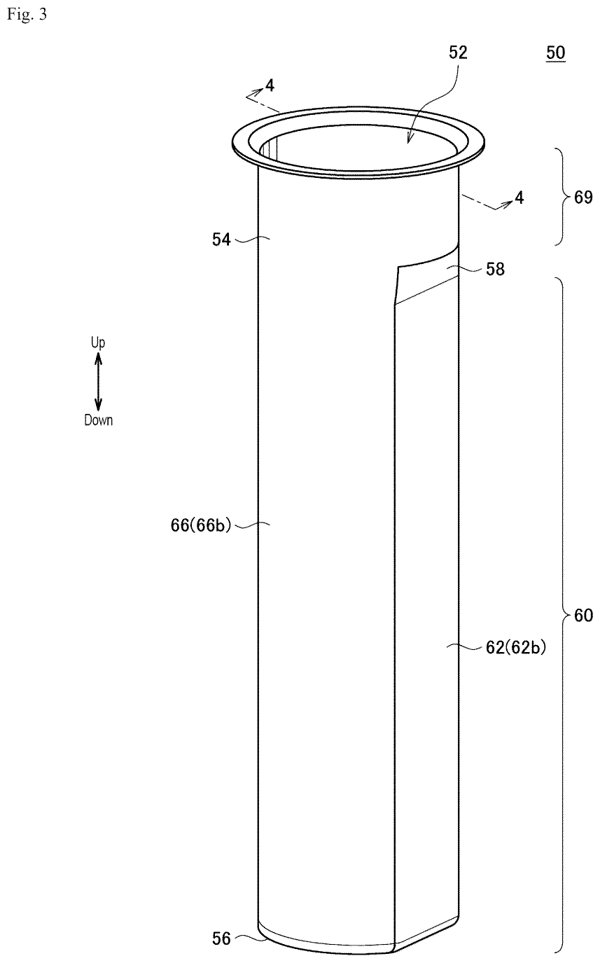

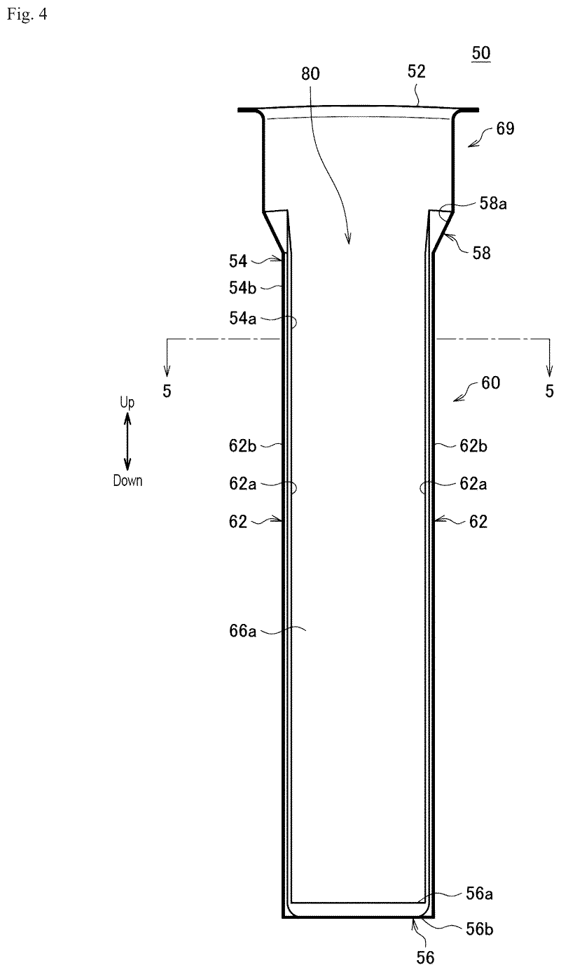

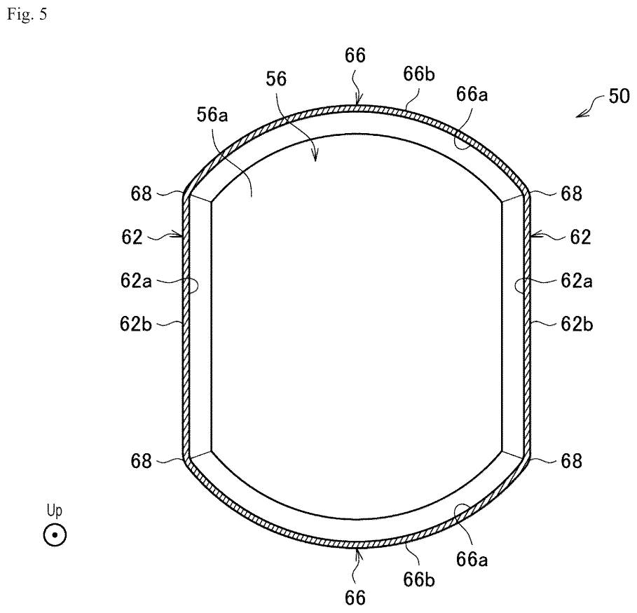

FIG. 3 is an oblique view of the accommodating portion 50 illustrated in FIG. 2. FIG. 4 is a cross-sectional view of the accommodating portion 50 taken along the line 4-4 illustrated in FIG. 3. FIG. 5 is a cross-sectional view of the accommodating portion 50 taken along the line 5-5 illustrated in FIG. 4. As illustrated in FIG. 3 to FIG. 5, the accommodating portion 50 is a bottomed tubular body comprising the opening 52, a side wall 54 and the bottom wall 56, which blocks the end portion on the opposite side to the opening 52. The side wall 54 has an inner surface 54a and an outer surface 54b. The bottom wall 56 has an inner surface 56a and an outer surface 56b. The stick-shaped substrate 150 is inserted into the accommodating portion 50 through the opening 52 and is accommodated in the internal space 80 surrounded by the side wall 54 and the bottom wall 56. The accommodating portion 50 is preferably made of a metal having a high thermal conductivity and may, for example, be made of SUS (steel use stainless) or the like. This allows for efficient heating of the stick-shaped substrate 150.

The stick-shaped substrate 150 is inserted and removed along the axial direction of the accommodating portion 50, which is a tubular body. Among the axial directions, the direction in which the stick-shaped substrate 150 is inserted is also referred to as “down”, and the direction in which the stick-shaped substrate 150 is withdrawn is also referred to as “up”. The axial direction is also referred to as the up-down direction. The up-down direction may be the longitudinal direction of the accommodating portion 50. Among the directions perpendicular to the up-down direction, the direction toward the central axis of the accommodating portion 50 is also referred to as inward and the direction moving away from the central axis is also referred to as outward.

As illustrated in FIG. 3 to FIG. 5, the accommodating portion 50 has a holding portion 60 that holds the stick-shaped substrate 150. The holding portion 60 includes pressing portions 62 that press a portion of the stick-shaped substrate 150, and non-pressing portions 66. The pressing portions 62 have an inner surface 62a and an outer surface 62b. The non-pressing portions 66 have an inner surface 66a and an outer surface 66b. The pressing portions 62 and the non-pressing portions 66 are portions of the side wall 54 of the accommodating portion 50. The pressing portions 62 are an example of first side walls. The non-pressing portions 66 are an example of second side walls that are different from the first side walls.

The opening 52 of the accommodating portion 50 can preferably accept the stick-shaped substrate without applying pressure thereto. In other words, the opening 52 of the accommodating portion 50 is preferably configured to be larger than the stick-shaped substrate 150 in a plane perpendicular to the up-down direction. The shape of the opening 52 of the accommodating portion 50 in a plane perpendicular to the up-down direction may be polygonal or elliptical, but is preferably circular.

As illustrated in FIG. 2, the heating units 40 are disposed on the outer surfaces 62b of the pressing portions 62. The heating units 40 are preferably disposed on the outer surfaces 62b of the pressing portions 62 without a gap. Furthermore, the heating units 40 are preferably disposed over the entire outer surface 62b of each pressing portion 62. However, the heating units 40 are preferably disposed so as not to protrude beyond the outer surfaces 62b of the pressing portions 62. Of course, the heating units 40 may be disposed so as to protrude from the outer surfaces 62b of the pressing portions 62 onto the outer surface 66b of the non-pressing portions 66.

As illustrated in FIG. 2, the heating units 40 each have a heat generating region 44 and a non-heat generating region 45. The heat generating regions 44 are regions that generate heat when an electric current flows through the heating units 40. The non-heat generating regions 45 are regions that generate less heat than the heat generating regions 44. The non-heat generating regions 45 are regions that do not generate heat or generate very little heat when an electric current flows. The heat generating regions 44 are disposed on the outer surfaces 62b of the pressing portions 62. With this configuration, it is possible to heat the stick-shaped substrate 150 efficiently while pressing the stick-shaped substrate 150 with the pressing portions 62.

As illustrated in FIG. 3 to FIG. 5, in the present embodiment, the accommodating portion 50 has two pressing portions 62 and two non-pressing portions 66. Furthermore, the pressing portions 62 and the non-pressing portions 66 are arranged alternately along the circumferential direction of the accommodating portion 50. In particular, the two pressing portions 62 of the holding portion 60 oppose one another. The distance between the inner surfaces 62a of the two pressing portions 62 is, at least partially, less than the width of the part of the stick-shaped substrate 150 that is disposed between the pressing portions 62 when inserted into the accommodating portion 50. With this configuration, the stick-shaped substrate 150 can be pressed by the two opposing pressing portions 62.

As illustrated in FIG. 3 to FIG. 5, the inner surfaces 66a of the non-pressing portions 66 of the holding portion 60 are curved in a plane perpendicular to the longitudinal direction of the accommodating portion 50. Preferably, the shape of the inner surfaces 66a of the non-pressing portions 66 in a plane perpendicular to the longitudinal direction of the accommodating portion 50 is identical to the shape of the opening 52 in the plane perpendicular to the longitudinal direction of the accommodating portion 50 at any position in the longitudinal direction of the accommodating portion 50. In other words, the inner surfaces 66a of the non-pressing portions 66 are preferably formed by extending the inner surface of the accommodating portion 50 that forms the opening 52 in the longitudinal direction. The outer surfaces 66b of the non-pressing portions 66 of the holding portion 60 are curved parallel to the inner surfaces 66a.

As illustrated in FIG. 5, the inner surfaces 62a of the pressing portions 62 comprise a pair of opposing planar pressing surfaces having a planar shape. Meanwhile, the inner surfaces 66a of the non-pressing portions 66 connect both ends of the pair of planar pressing surfaces and comprise a pair of opposing curved non-pressing surfaces having a curved surface shape. As illustrated in the drawings, the curved non-pressing surfaces may have an overall arc-shaped cross-section in a plane perpendicular to the longitudinal direction of the accommodating portion 50. The outer surfaces 62b of the pressing portions 62 and the outer surfaces 66b of the non-pressing portions 66 may be connected to one another at an angle, and boundaries 68 may be formed between the outer surfaces 62b of the pressing portions 62 and the outer surfaces 66b of the non-pressing portions 66. As illustrated in FIG. 5, the pressing portions 62 and the non-pressing portions 66 (i.e. the side wall 54 of the accommodating portion 50) may have a uniform thickness. For example, the pressing portions 62 may comprise a flat plate. In addition, the non-pressing portions 66 may comprise a curved plate that curves to the outside of the accommodating portion 50 along the circumferential direction of the accommodating portion 50.

As illustrated in FIG. 3 and FIG. 4, the accommodating portion 50 preferably has first guide portions 58 having a tapered surface 58a that connects the inner surface of the accommodating portion 50 (i.e. a non-holding portion 69) forming the opening 52 and the inner surfaces 62a of the pressing portions 62. The first guide portions 58 provide a smooth connection between the pressing portions 62 and the non-holding portion 69, thereby allowing the stick-shaped substrate 150 to be suitably guided into the holding portion 60 in the process of the stick-shaped substrate 150 being inserted into the accommodating portion 50.

As illustrated in FIG. 4, the accommodating portion 50 preferably has a tubular non-holding portion 69 between the opening 52 and the holding portion 60. The non-holding portion 69 is a part of the accommodating portion 50 that does not contribute to holding the stick-shaped substrate 150. For example, in a plane perpendicular to the longitudinal direction of the accommodating portion 50, the non-holding portion 69 may be formed to be larger than the stick-shaped substrate 150. This allows for easy insertion of the stick-shaped substrate 150 into the accommodating portion 50.

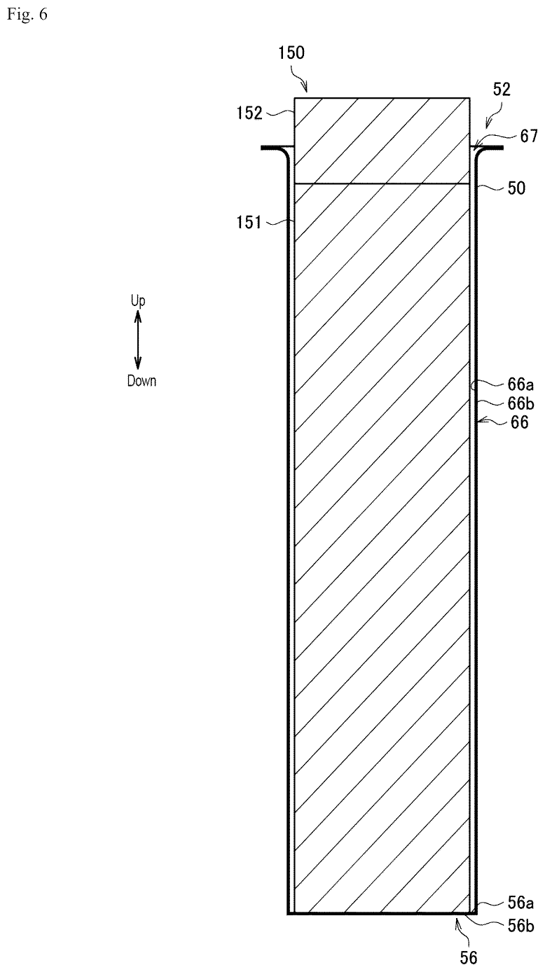

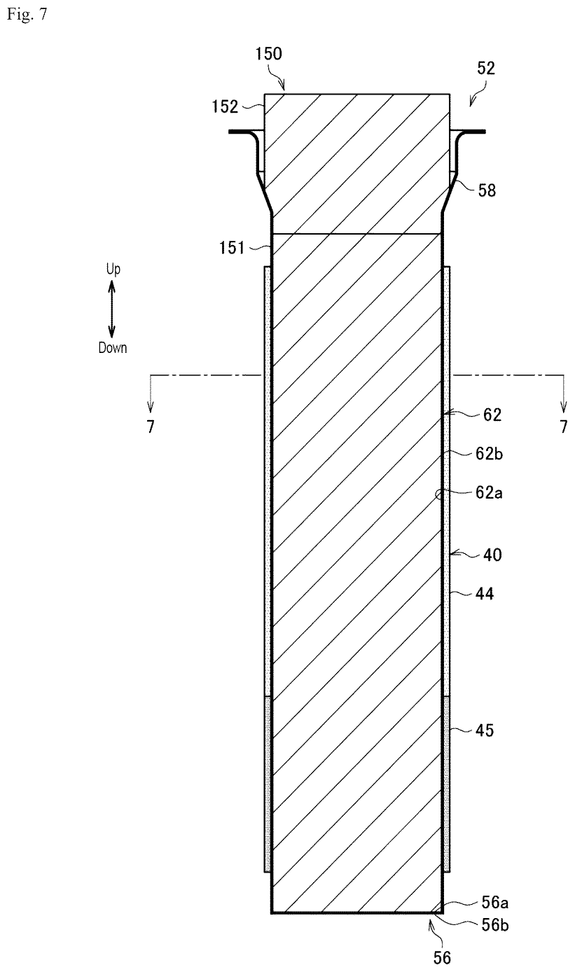

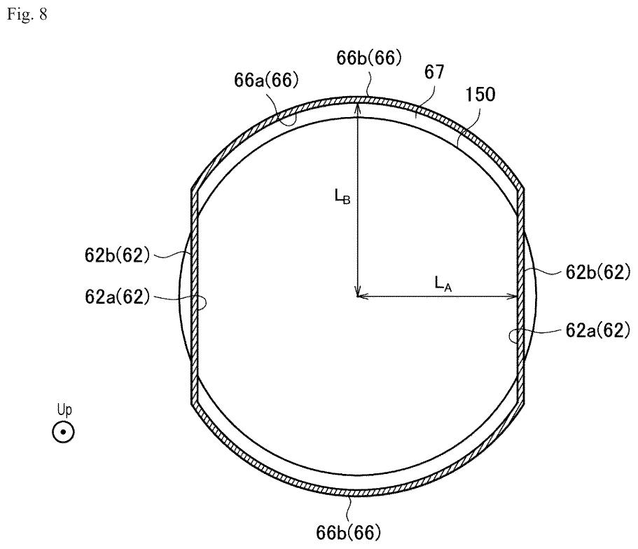

FIG. 6 is a longitudinal cross-sectional view of the accommodating portion 50 including the non-pressing portions 66, in a state in which the stick-shaped substrate 150 is being held by the holding portion 60. FIG. 7 is a longitudinal cross-sectional view of the accommodating portion 50 including the pressing portions 62, in a state in which the stick-shaped substrate 150 is being held by the holding portion 60. FIG. 8 is a cross-sectional view of the accommodating portion 50 taken along the line 7-7 illustrated in FIG. 7. It should be noted that, in FIG. 8, a cross-section through the stick-shaped substrate 150 in the state before being pressed is shown in order to make it easy to recognize that the stick-shaped substrate 150 is pressed by the pressing portions 62.

As illustrated in FIG. 6, the stick-shaped substrate 150 is pressed by the pressing portions 66, and the inner surfaces 66a of the pressing portions 66 and the stick-shaped substrate 150 are in close contact with one another. Meanwhile, as illustrated in FIG. 7, a gap 67 is formed between the inner surfaces 66a of the non-pressing portions 66 and the stick-shaped substrate 150.

As illustrated in FIG. 8, the gap 67 between the inner surfaces 66a of the non-pressing portions 66 and the stick-shaped substrate 150 is substantially maintained even when the stick-shaped substrate 150 is held by the holding portion 60 and the stick-shaped substrate 150 is pressed and deformed by the pressing portions 62. If the accommodating portion 50 has a counterflow air intake and exhaust configuration, the gap 67 can form an air flow path that provides communication between the opening 52 and the tip of the stick-shaped substrate 150.

As illustrated in FIG. 8, in a state in which the stick-shaped substrate 150 is being held by the holding portion 60, a distance LA between the inner surface 62a of the pressing portions 62 and the center of the stick-shaped substrate 150 is less than a distance LB between the inner surface 66a of the non-pressing portions 66 and the center of the stick-shaped substrate 150. With this configuration, the distance between the heating units 40 disposed on the outer surface 62b of the pressing portions 62 and the center of the stick-shaped substrate 150 can be reduced compared to a case in which the pressing portions 62 are not provided. The stick-shaped substrate 150 heating efficiency can thus be improved.

As illustrated in FIG. 3 to FIG. 8, the outer peripheral surface of the holding portion 60 preferably has the same shape and size (the outer peripheral length of the holding portion 60 in a plane perpendicular to the longitudinal direction of the holding portion 60) along the entire longitudinal length of the holding portion 60. This makes it possible to ensure the gap 67 while uniformly pressing the stick-shaped substrate 150, over the entire holding portion 60 in the up-down direction.

As described hereinabove, the inhalation device 100 according to the present embodiment holds and heats the stick-shaped substrate 150 while pressing the same by means of the pressing portions 62. This configuration makes it possible to improve the stick-shaped substrate 150 heating efficiency compared to a case in which the stick-shaped substrate 150 is heated without being pressed.

### <2. 2. Configuration of Heating System 30>

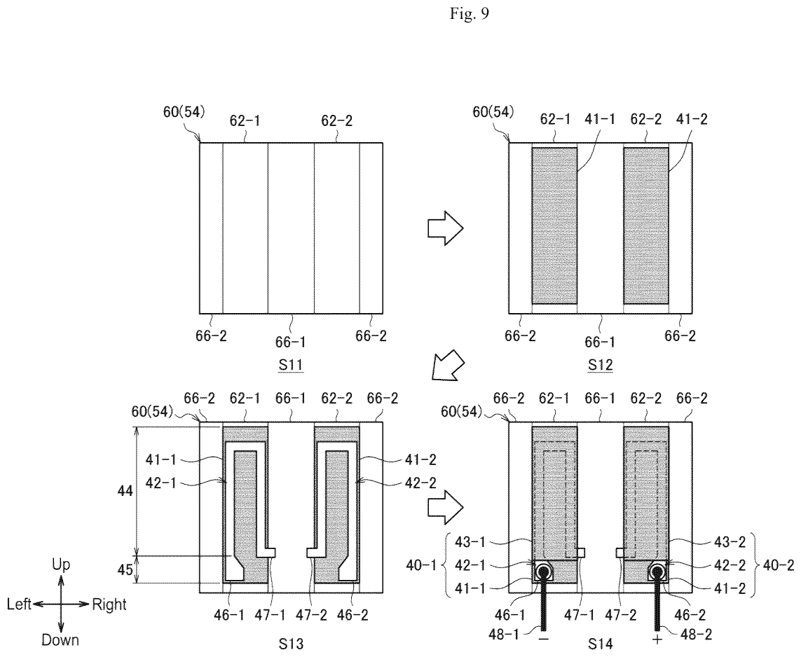

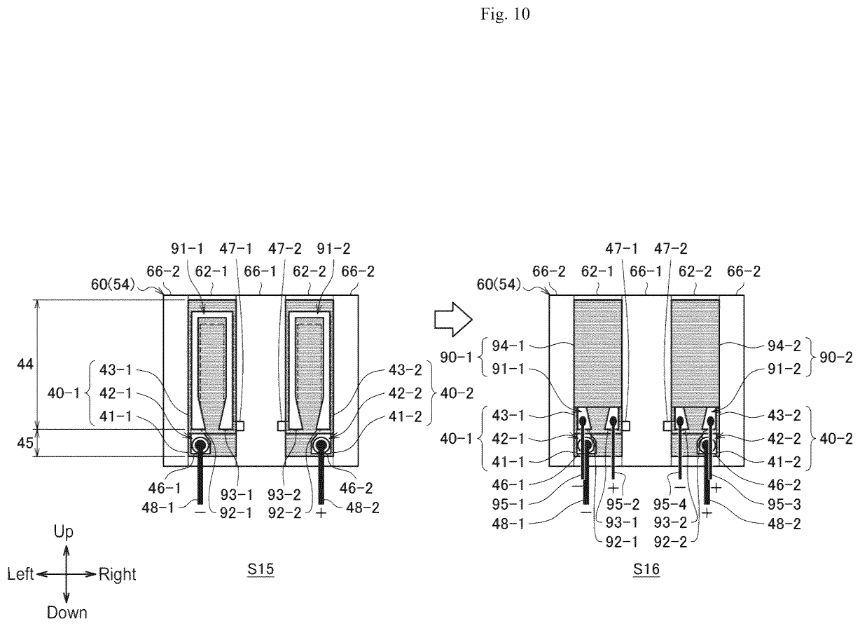

The heating system 30 according to the present embodiment is manufactured by laminating the components constituting the heating system 30 sequentially onto the outer side of the side wall 54 of the accommodating portion 50. The configuration of the heating system 30 will now be described while describing the steps for manufacturing the heating system 30 with reference to FIG. 9 and FIG. 10.

FIG. 9 and FIG. 10 are drawings illustrating an example of the steps for manufacturing the heating system 30 according to the present embodiment. The steps for manufacturing the heating system 30 according to the present embodiment proceed sequentially through manufacturing steps S11 to S16 illustrated in FIGS. 9 and 10. In the following, the two pressing portions 62 of the holding portion 60 are in some cases distinguished as the pressing portion 62-1 and the pressing portion 62-2. Similarly, the two non-pressing portions 66 of the holding portion 60 are in some cases distinguished as the non-pressing portion 66-1 and the non-pressing portion 66-2. In FIG. 9 and FIG. 10, each manufacturing step is illustrated on an unfolded view in which the side wall 54 of the accommodating portion 50 (in particular, the part corresponding to the holding portion 60) is divided at the center of the non-pressing portion 66-2 and is unfolded. The left-right direction in the unfolded views corresponds to the circumferential direction of the accommodating portion 50.

In manufacturing step S11 of FIG. 9, the accommodating portion 50 is illustrated in a state before the other components have been laminated onto the holding portion 60.

In manufacturing step S12 of FIG. 9, first electrically insulating layers 41 (41-1 and 41-2) are first laminated onto the pressing portion 62. Specifically, the first electrically insulating layer 41-1 is laminated onto the outer side of the pressing portion 62-1, and the first electrically insulating layer 41-2 is laminated onto the outer side of the pressing portion 62-2. The first electrically insulating layers 41 are made of an electrically insulating material. Examples of materials that can be used to form the first electrically insulating layers 41 include glass and ceramic, for example. The first electrically insulating layers 41 are laminated using a vapor deposition process or a printing process. A vapor deposition process is a process in which a substance is vaporized toward the surface of a target object to form a thin film coating. A printing process is a process in which a liquid is ejected toward the surface of the target object to form a thin film coating.

In manufacturing step S13 of FIG. 9, resistive heating layers 42 (42-1 and 42-2) are laminated onto the outer sides of the pressing portions 62 of the partially manufactured heating system 30 that has passed through manufacturing step S12. Specifically, the resistive heating layer 42-1 is laminated onto the outer side of the first electrically insulating layer 41-1 laminated onto the pressing portion 62-1, and the resistive heating layer 42-2 is laminated onto the outer side of the first electrically insulating layer 41-2 laminated onto the pressing portion 62-2. In particular, the resistive heating layers 42 are laminated onto the first electrically insulating layers 41 in the shape of a single line that moves back and forth in the up-down direction while leaving a gap in the left-right direction. The resistive heating layers 42 are made of an electrically conductive material. Examples of materials that can be used to form the resistive heating layers 42 include metallic materials such as SUS and non-metallic materials such as silicon carbide. The resistive heating layers 42 may also be made of an electrically conductive paste-like material. An example of such a material is a material in which a main constituent comprising silver is mixed with a resistance adjusting agent. When an electric current flows through the resistive heating layers 42, Joule heat corresponding to the electrical resistance is emitted. The resistive heating layers 42 are laminated using a vapor deposition process or a printing process.

Here, as illustrated in FIG. 9, the resistive heating layer 42-1 forms an open circuit having a first end portion 46-1 and a second end portion 47-1 as the two ends thereof. The resistive heating layer 42-2 also forms an open circuit having a first end portion 46-2 and a second end portion 47-2 as the two ends thereof. The first end portions 46 (46-1 and 46-2) are disposed within the first electrically insulating layers 41. In particular, the first end portions 46 are disposed in lower end portions of the first electrically insulating layers 41. Meanwhile, the second end portions 47 (47-1 and 47-2) are disposed protruding from the first electrically insulating layers 41. In particular, the second end portions 47 protrude from the first electrically insulating layers 41, further protrude from the pressing portions 62, and are disposed in the non-pressing portion 66.

In manufacturing step S14 of FIG. 9, second electrically insulating layers 43 (43-1 and 43-2) are laminated onto the outer sides of the pressing portions 62 of the partially manufactured heating system 30 that has passed through manufacturing step S13. Specifically, a second electrically insulating layer 43-1 is laminated onto the outside of the first electrically insulating layer 41-1 and the resistive heating layer 42-2 that are laminated onto the pressing portion 62-1, and a second electrically insulating layer 43-2 is laminated onto the outside the first electrically insulating layer 41-2 and the resistive heating layer 42-2 that are laminated onto the pressing portion 62-2. Similarly to the first electrically insulating layers 41, the second electrically insulating layers 43 are made of an electrically insulating material. The second electrically insulating layers 43 are laminated using a vapor deposition process or a printing process.

Further, in manufacturing step S14, a conducting wire 48-1 is connected to the resistive heating layer 42-1 and a conducting wire 48-2 is connected to the resistive heating layer 42-2. Specifically, the conducting wire 48-1 is connected to the first end portion 46-1 of the resistive heating layer 42-1 and the conducting wire 48-2 is connected to the first end portion 46-2 of the resistive heating layer 42-2. The conducting wires 48 (48-1 and 48-2) are connected to the power source unit 111. As an example, the first end portion 46-1 of the resistive heating layer 42-1 is connected to the negative electrode of the power source unit portion 111 via the conducting wire 48-1. Meanwhile, the first end portion 46-2 of the resistive heating layer 42-2 is connected to the positive electrode of the power source unit 111 via the conducting wire 48-2. The power source unit 111 then supplies electric power to the resistive heating layers 42 on the basis of control by the control unit 116, causing the resistive heating layers 42 to generate heat.

Here, the accommodating portion 50 is made of an electrically conductive material. SUS can be cited as an example of a material used to form the accommodating portion 50.

The second end portion 47-1 of the resistive heating layer 42-1 protrudes from the first electrically insulating layer 41-1 and is connected to the accommodating portion 50, and is electrically connected to the power source unit 111 via the accommodating portion 50. Similarly, the second end portion 47-2 of the resistive heating layer 42-2 protrudes from the first electrically insulating layer 41-2 and is connected to the accommodating portion 50, and is electrically connected to the power source unit 111 via the accommodating portion 50. More specifically, the second end portion 47-1 of the resistive heating layer 42-1 and the second end portion 47-2 of the resistive heating layer 42-2 adjacent to the resistive heating layer 42-1 are electrically connected via the accommodating portion 50. Then, the first end portion 46-1 of the resistive heating layer 42-1 is electrically connected to the power source unit 111 via the conducting wire 48-1, and the first end portion 46-2 of the resistive heating layer 42-2 is electrically connected to the power source unit 111 via the conducting wire 48-2. With the configuration described hereinabove, the conducting wire 48-1, the resistive heating layer 42-1, the accommodating portion 50, the resistive heating layer 42-2, and the conducting wire 48-2 form one series circuit that is connected to the power source unit 111. When the power source unit 111 supplies electric power to this series circuit, heat can be generated in the resistive heating layer 42-1 and the resistive heating layer 42-2.

The first electrically insulating layer 41-1, the resistive heating layer 42-1 and the second electrically insulating layer 43-1 described hereinabove constitute a heating unit 40-1. Further, the first electrically insulating layer 41-2, the resistive heating layer 42-2 and the second electrically insulating layer 43-2 constitute a heating unit 40-2. Here, each component constituting the heating units 40 (40-1 and 40-2) is laminated using a printing process or a vapor deposition process. The occurrence of defects such as misalignment and peeling can thus be prevented, and consequently the manufacturing accuracy of the heating system 30 can be improved in comparison with other manufacturing methods such as a method in which the heating units 40 are manufactured separately and are bonded to the accommodating portion 50. As a result, it is possible to improve the stick-shaped substrate 150 heating efficiency, thereby improving the quality of the user experience.

Supplementary information regarding the features of the heating units 40 will now be provided.

Referring again to manufacturing steps S12 to S14, the first electrically insulating layer 41-1 is laminated inward of the resistive heating layer 42-1, and the second electrically insulating layer 43-1 is laminated outward of the resistive heating layer 42-1. Furthermore, at least a portion of the resistive heating layer 42-1 is sandwiched between the first electrically insulating layer 41-1 and the resistive heating layer 42-2. With this configuration, it is possible to prevent a short circuit within the resistive heating layer 42-1 via a component on the inner side of the heating units 40 (for example, the accommodating portion 50) or a component on the outer side of the heating units 40 (for example, a heat diffusion layer, discussed hereinafter). The same applies to the first electrically insulating layer 41-2, the resistive heating layer 42-2 and the second electrically insulating layer 43-2.

Referring again to manufacturing step S13, the resistive heating layer 42-1 and the resistive heating layer 42-2 are laminated onto the outer sides of the pressing portion 62-1 and the pressing portion 62-2 adjacent to and on both sides of the non-pressing portion 66-1, in a state separated from one another at the non-pressing portions 66-1. With this configuration, the resistive heating layers 42 can be disposed on the flat surfaces on the pressing portions 62. The occurrence of defects such as misalignment and peeling can thus be prevented, and consequently the manufacturing accuracy of the heating system 30 can be improved in comparison with a case in which the resistive heating layers 42 are disposed on the curved surfaces on the non-pressing portions 66. As a result, it is possible to improve the stick-shaped substrate 150 heating efficiency, thereby improving the quality of the user experience.

Referring again to manufacturing step S13, the second end portion 47-1 of the resistive heating layer 42-1 that protrudes from the first electrically insulating layer 41-1 protrudes from the pressing portion 62-1 and is connected to the non-pressing portion 66-1. Meanwhile, the second end portion 47-2 of the resistive heating layer 42-2 that protrudes from the first electrically insulating layer 41-2 protrudes from the pressing portion 62-2 and is connected to the non-pressing portion 66-1. That is, the second end portion 47-1 of the resistive heating layer 42-1 and the second end portion 47-2 of the resistive heating layer 42-2 are disposed protruding in directions that approach one another from the left and right ends of the non-pressing portion 66-1. With this configuration, the distance between the second end portion 47-1 of the resistive heating layer 42-1 and the second end portion 47-2 of the resistive heating layer 42-2 can be minimized. As a result, it is possible to facilitate the conduction of electricity between the resistive heating layer 42-1 and the resistive heating layer 42-2.

Referring again to manufacturing step S13, the resistive heating layers 42 laminated in the heat generating region 44 are configured to be thin. This allows the electrical resistance of the resistive heating layers 42 laminated in the heat generating region 44 to be increased to generate a high Joule heat when electric power is applied. The resistive heating layers 42 laminated in the heat generating region 44 are examples of first parts of the resistive heating layers 42 that generate heat when a current flows through. Meanwhile, the resistive heating layers 42 laminated in the non-heat generating regions 45 of the heating units 40 are configured to be wider that the resistive heating layers 42 laminated in the heat generating region 44. This allows the electrical resistance of the resistive heating layers 42 laminated in the non-heat generating regions 45 to be reduced so that no Joule heat or only a very small amount of Joule heat is generated when electric power is applied. The resistive heating layers 42 laminated in the non-heat generating region 45 are examples of second parts of the resistive heating layers 42 that generate less heat than the first parts of the resistive heating layers 42.

Referring again to manufacturing step S14, the first end portions 46 to which the conducting wires 48 are connected are configured in the resistive heating layers 42 in the non-heat generating regions 45, which are configured to be wider than the resistive heating layers 42 in the heat generating regions 44. This makes it possible to prevent heat transfer to the conducting wires 48 and to prevent the connecting parts between the conducting wires 48 and the resistive heating layers 42 from being damaged by heat.

Referring again to manufacturing step S14, the conducting wires 48 are only connected at one of the two ends of each resistive heating layer 42. With this configuration, the number of conducting wires 48 can be reduced in comparison with a case in which conducting wires 48 are connected to both ends of the resistive heating layers 42. This makes it possible to inhibit the occurrence of poor connections between the conducting wires 48 and the resistive heating layers 42, thereby improving the quality of the user experience.

The resistive heating layers 42 are disposed in positions corresponding to the substrate portion 151, in which the aerosol source is distributed, of the stick-shaped substrate 150 accommodated in the accommodating portion 50. Specifically, in a state in which the stick-shaped substrate 150 is accommodated in the accommodating portion 50, as illustrated in FIG. 7, the heat generating region 44 in which the resistive heating layers 42 are laminated is disposed in a position within the pressing portion 62 corresponding to the substrate portion 151. With this configuration, it is possible to improve the stick-shaped substrate 150 heating efficiency.

It is desirable that the part of the outer periphery of the accommodating portion 50 on which the first electrically insulating layers 41 are laminated occupies less than 50% of the outer periphery of the accommodating portion 50. More simply, it is desirable that the pressing portions 62 occupy less than 50% of the outer periphery of the accommodating portion 50. With this configuration, the area of the heat generating region 44 can be reduced to increase the watt density. As a result, it is possible to improve the stick-shaped substrate 150 heating efficiency.

Supplementary information regarding the features of the heating units 40 has been provided above. The subsequent manufacturing steps will next be described with reference to FIG. 10.

In manufacturing step S15 of FIG. 10, electrically conductive layers 91 (91-1 and 91-2) are laminated onto the outer sides of the pressing portions 62 of the partially manufactured heating system 30 that has passed through manufacturing step S14. Specifically, the electrically conductive layer 91-1 is laminated onto the outer side of the heating unit 40-1 (in particular, the second electrically insulating layer 43-1) laminated onto the pressing portion 62-1. In addition, the electrically conductive layer 91-2 is laminated onto the outer side of the heating unit 40-2 (in particular, the second electrically insulating layer 43-2) laminated onto the pressing portion 62-2. In particular, the electrically insulating layers 91 are laminated onto the second electrically insulating layers 43 in the shape of a single line that moves back and forth in the up-down direction while leaving a gap in the left-right direction, and area laminated in a shape that follows (that is, overlaps) the resistive heating layers 42. The resistive heating layers 42 are made of an electrically conductive material. The electrically conductive layers 91 are laminated using a vapor deposition process or a printing process.

Here, as illustrated in FIG. 10, the electrically conductive layer 91-1 forms an open circuit having a first end portion 92-1 and a second end portion 93-1 as the two ends thereof. The electrically conductive layer 91-2 also forms an open circuit having a first end portion 92-2 and a second end portion 93-2 as the two ends thereof. In particular, the first end portions 92 (92-1 and 92-2) and the second end portions 93 (93-1 and 93-2) of the electrically insulating layer 91 are disposed on lower end portions of the second electrically insulating layers 43. Furthermore, the electrically conductive layers 91 are disposed entirely within the second electrically insulating layers 43. Such a configuration makes it possible to prevent situations in which the electrically conductive layers 91 and the resistive heating layers 42 come into contact with one another and cause a short circuit.

In manufacturing step S16 of FIG. 10, third electrically insulating layers 94 (94-1 and 94-2) are laminated onto the outer sides of the pressing portions 62 of the partially manufactured heating system 30 that has passed through manufacturing step S15. Specifically, the third electrically insulating layer 94-1 is laminated onto the outer side of the second electrically insulating layer 43-1 laminated onto the pressing portion 62-1 and the electrically insulating layer 91-1. Furthermore, the third electrically insulating layer 94-2 is laminated onto the outer side of the second electrically insulating layer 43-2 laminated onto the pressing portion 62-2 and the electrically insulating layer 91-2. Similarly to the first electrically insulating layers 41 and the second electrically insulating layers 43, the third electrically insulating layers 94 are made of an electrically insulating material. The third electrically insulating layers 94 are laminated using a vapor deposition process or a printing process.

Further, in manufacturing step S16, conducting wires 95-1 and 95-2 are connected to the electrically conductive layer 91-1 and conducting wires 95-3 and 95-4 are connected to the electrically conductive layer 91-2. Specifically, the conducting wire 95-1 is connected to the first end portion 92-1 of the electrically conductive layer 91-1 and the conducting wire 95-2 is connected to the second end portion 93-1 of the electrically conductive layer 91-1. Meanwhile, the conducting wire 95-3 is connected to the first end portion 92-2 of the electrically conductive layer 91-2 and the conducting wire 95-4 is connected to the second end portion 93-2 of the electrically conductive layer 91-2. The conducting wires 95 (95-1 to 95-4) are connected to the power source unit 111. Specifically, the first end portion 92-1 of the electrically conductive layer 91-1 is connected to the negative electrode of the power source unit portion 111 via the conducting wire 95-1. Meanwhile, the second end portion 93-1 of the electrically conductive layer 91-1 is connected to the positive electrode of the power source unit 111 via the conducting wire 95-2. Furthermore, the first end portion 92-2 of the electrically conductive layer 91-2 is connected to the positive electrode of the power source unit portion 111 via the conducting wire 95-3. Meanwhile, the second end portion 93-2 of the electrically conductive layer 91-2 is connected to the negative electrode of the power source unit 111 via the conducting wire 95-4. Then, the power source unit 111 applies a voltage to the electrically conductive layers 91 via the conducting wires 95 on the basis of control by the control unit 116.

The electrically conductive layer 91-1 and the third electrically insulating layer 94-1 described hereinabove constitute a measuring unit 90-1. In addition, the electrically conductive layer 91-2 and the third electrically insulating layer 94-2 constitute a measuring unit 90-2. Supplementary information regarding the features of the measuring units 90 (90-1 and 90-2) will now be provided.

The measuring units 90 are components for measuring the temperature of the heating units 40 (in particular, the resistive heating layers 42). Specifically, the control unit 116 calculates the temperature of each electrically conductive layer 91 on the basis of the electrical resistance value of the electrically conductive layer 91. The electrical resistance value of each resistive heating layer 91 is measured on the basis of the amount of voltage drop between the first end portion 92 and the second end portion 93. The control unit 116 then measures (for example, estimates) the temperature of the resistive heating layers 42 on the basis of the temperature of the electrically conductive layers 91. The control unit 116 controls the temperature to which the stick-shaped substrate 150 is heated by estimating and controlling the temperature of the resistive heating layers 42 using the measuring units 90. In the present embodiment, it is considered that the temperature of the electrically conductive layers 91 matches or substantially matches the temperature of the resistive heating layers 42 since the electrically conductive layers 91 and the resistive heating layers 42 are adjacent to one other across the second electrically insulating layers 43. As such, the control unit 116 can measure the temperature of the resistive heating layers 42 with high accuracy. As a result, the temperature to which the stick-shaped substrate 150 is heated can be suitably controlled, thereby improving the quality of the user experience.

Referring again to manufacturing step S15 of FIG. 10, the electrically conductive layers 91 are laminated so as to overlap at least a portion of the resistive heating layers 42. With this configuration, the temperature of the electrically conductive layers 91 and the temperature of the resistive heating layers 42 can be made to match or substantially match. It is therefore possible to improve the accuracy with which the temperature of the heating units 40 is measured using the measuring units 90.

In particular, the electrically conductive layers 91 are laminated so as to overlap at least a portion of the resistive heating layers 42 laminated in the heat generating region 44. Referring again to manufacturing step S15 of FIG. 10, the electrically conductive layers 91 are laminated so as to overlap almost entirely the resistive heating layers 42 disposed within the heat generating region 44. With this configuration, the temperature of the electrically conductive layers 91 and the temperature of the resistive heating layers 42 laminated in the heat generating region 44 can be made to match more closely. It is therefore possible to improve further the accuracy with which the temperature of the heating units 40 is measured using the measuring units 90.

The direction in which the current flows in the resistive heating layers 42 coincides with the direction in which the current flows in the parts of the electrically conductive layers 91 that overlap the resistive heating layers 42. Specifically, in the resistive heating layer 42-1, a current flows from the first end portion 46-1 on the negative electrode side to the second end portion 47-1 on the positive electrode side. Meanwhile, in the electrically conductive layer 91-1, a current flows from the first end portion 92-1 on the negative electrode side to the second end portion 93-1 on the positive electrode side. In this way, the direction of current flow coincides in the overlapping part between the resistive heating layer 42-1 and the electrically conductive layer 91-1. With this configuration, the first end portion 46-1 of the resistive heating layer 42-1 and the first end portion 92-1 of the electrically conductive layer 91-1, which are disposed close to one another, are both connected to the negative electrode. Consequently, it is not necessary for either the conducting wire 48-1 or the conducting wire 95-1 to be routed circuitously, for example, in order to connect to the power source unit 111, and the lengths of the conducting wire 48-1 and the conducting wires 95-1 and 95-2 can be minimized. Minimizing the lengths of the conducting wires 95-1 and 95-2 makes it possible to minimize the effects of the conducting wires 95-1 and 95-2 on the measured electrical resistance value of the electrically conductive layers 91, thereby making it possible to improve the accuracy with which the temperature of the resistive heating layers 42 is measured. Furthermore, since parallel currents flow in the same direction, magnetic fields in opposite directions are generated between the parallel currents, and a force is generated in the direction which brings the resistive heating layer 42-1 and the electrically conductive layer 91-1 closer together. Therefore, when currents flow simultaneously through the resistive heating layer 42-1 and the electrically conductive layer 91-1, the resistive heating layer 42-1 and the electrically conductive layer 91-1 are attracted and come into close contact with one another, making it possible to improve the accuracy with which the temperature of the resistive heating layer 42 is measured. The same applies to the resistive heating layer 42-2 and the electrically conductive layer 91-2.

The temperature coefficient of resistance of the electrically conductive layers 91 and the temperature coefficient of resistance of the resistive heating layers 42 are different. The temperature coefficient of resistance is the temperature characteristic of an electrical resistance value. If the electrical resistance value at a temperature t is Rt, a value obtained by dividing an increase in an electrical resistance value r when the temperature rises by 1° C. from the temperature t by an electrical resistance value R can be defined as the temperature coefficient of resistance at the temperature t.

In particular, the rate of variation in the temperature coefficient of resistance of the electrically conductive layers 91 with respect to temperature is less than the rate of variation in the temperature coefficient of resistance of the resistive heating layers 42 with respect to temperature. The rate of variation in the temperature coefficient of resistance with respect to temperature is the variation in the temperature coefficient of resistance when the temperature t varies. The rate of variation in the temperature coefficient of resistance with respect to temperature may be regarded as the variance or deviation of the temperature coefficient of resistance. The rate of variation in the temperature coefficient with respect to temperature can also be said to be the stability of the temperature coefficient of resistance. The smaller the rate of variation in the temperature coefficient of resistance with respect to temperature, the more it is possible to improve the temperature measurement accuracy based on the electrical resistance value. Therefore, by measuring the temperature of the resistive heating layers 42 on the basis of the electrical resistance value of the electrically conductive layers 91 rather than measuring the temperature of the resistive heating layers 42 on the basis of the electrical resistance value of the resistive heating layers 42, it is possible to improve the accuracy with which the temperature of the resistive heating layers 42 is measured.

More specifically, the electrically conductive layers 91 may be made of a single metal. As an example, the electrically conductive layers 91 may be made of a metal such as copper, silver, gold, SUS or Chromel. Meanwhile, the resistive heating layers 42 may be made of an alloy. As an example, the resistive heating layers 42 may be made of an alloy containing two or more metallic materials such as silver, palladium, aluminum, or SUS. With this configuration, it is possible to improve the temperature rise efficiency of the resistive heating layers 42 while stabilizing the temperature coefficient of resistance of the electrically conductive layers 91.

The manufacturing steps of the heating system 30 and the configuration of the heating system 30 have been described above.

It should be noted that the heating system 30 may include other components in addition to the heating units 40, the accommodating portion 50, the measuring units 90, and the heat insulating portions 70.

As an example, the heating system 30 may include a heat diffusion layer. The heat diffusion layer may be wrapped around and laminated onto the outer side of the measuring units 90 of the accommodating portion 90, inward of the heat insulating portion 70. The heat diffusion layer allows the heat of the heating units 40 laminated onto the pressing portions 62 to be diffused throughout the entire accommodating portion 50 including the non-pressing portions 66. As a result, the stick-shaped substrate 150 accommodated in the accommodating portion 50 can be heated efficiently. The heat diffusion layer may, for example, be a graphite sheet obtained by forming graphite into the shape of a sheet. It should be noted that the position in which the heat diffusion layer is laminated is not restricted to the above, it and may be laminated, for example, between the accommodating portion 50 and the first electrically insulating layers 41.

As another example, the heating system 30 may include a fixing means for fixing the components laminated onto the outer side of the accommodating portion 50 to the accommodating portion 50. An example of the fixing means a heat shrinkable tube. A heat shrinkable tube is a tubular member that shrinks upon application of heat. The heat shrinkable tube is made of a resin material, for example. The heat shrinkable tube is positioned so as to completely cover the partially manufactured heating system 30, including components other than the heat shrinkable tube, and shrinks when heated in this state, thereby securing each component laminated onto the outer side of the accommodating portion 50. With this configuration, it is possible to prevent positional displacement and the like of each component laminated onto the outer side of the accommodating portion.

### <3. Modified Example of Measuring Units 90>

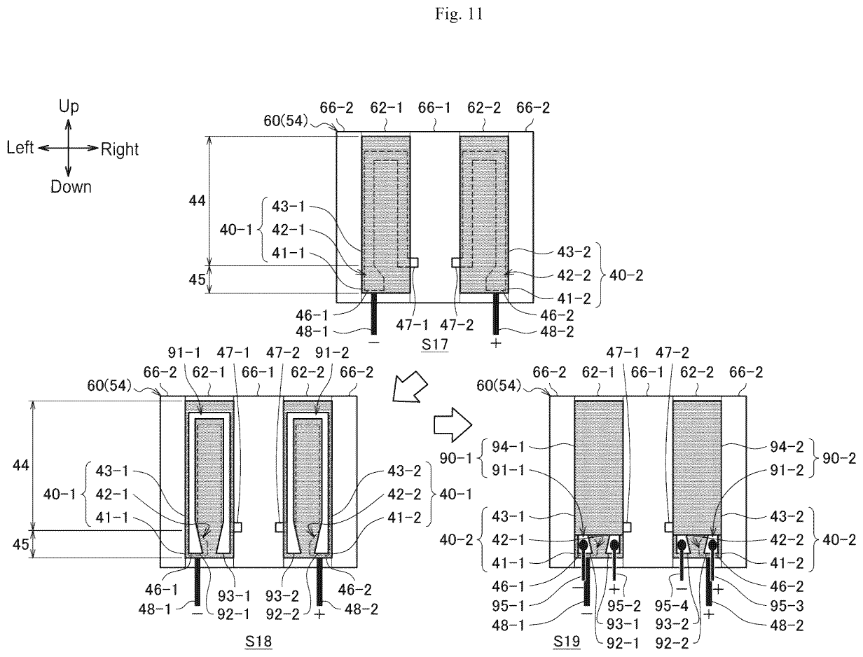

In the above embodiment, an example was described in which the electrically conductive layers 90 are disposed entirely within the heat generating region 44 of the heating units 40, but the present disclosure is not limited to such an example. A portion of each electrically conductive layer 91 may be disposed protruding from the heat generating region 44 of the heating units 40 into the non-heat generating region 45. Such a modified example will be described with reference to FIG. 11.

FIG. 11 is a diagram illustrating an example of the steps for manufacturing the heating system 30 according to the present modified example. The steps for manufacturing the heating system 30 according to the present modified example include manufacturing steps S17 to S19 illustrated in FIG. 11 instead of manufacturing steps S14 to S16 illustrated in FIG. 9 and FIG. 10. In the following, points of difference from manufacturing steps S14 to S16 will mainly be described, and descriptions of similar points will be omitted.

In manufacturing step S17 of FIG. 11, conducting wires 48 are connected to the resistive heating layers 42 of the partially manufactured heating system 30 that has passed through manufacturing step S13, and second electrically insulating layers 43 are laminated onto the outer sides of the pressing portions 62. However, in the present modified example, the second electrically insulating layers 43 are laminated so as to cover the entire surface of each first electrically insulating layer 41. The connecting parts between the resistive heating layers 42 and the conducting wires 48 are covered by the second electrically insulating layers 43.

In manufacturing step S18 of FIG. 11, the electrically conductive layers 91 are laminated onto the outer sides of the pressing portions 62 of the partially manufactured heating system 30 that has passed through manufacturing step S17. However, in the present modified example, the electrically conductive layers 91 are laminated not only in the heat generating region 44 but also in the non-heat generating region 45. In particular, the first end portions 92 and the second end portions 93 of the electrically conductive layers 91 are disposed in the non-heat generating region 45.

In manufacturing step S19 of FIG. 11, the third electrically insulating layers 94 are laminated onto the outer sides of the pressing portions 62 of the partially manufactured heating system 30 that has passed through manufacturing step S18, and the conducting wires 95 are connected to the electrically conductive layers 91. However, in the present modified example, the conducting wires 95 are connected to parts of the electrically conductive layers 91 that do not overlap the heat generating region 44. Specifically, the conducting wires 95 are connected to the first end portions 92 and the second end portions 93, disposed in the non-heat generating region 45, of the electrically conductive layers 91. With this configuration, it is possible to prevent heat transfer to the conducting wires 95 and to prevent the connecting parts between the conducting wires 95 and the electrically conductive layers 91 from being damaged by heat.

### <4. Modified Example of Heating Units 40>

The configuration of the heating units 40 is not limited to the example described above. Heating units 40 according to the various modified examples described below may be adopted as the heating units 40. Whichever heating unit 40 is adopted, the electrically conductive layers 91 should be disposed so as to overlap at least a portion of each resistive heating layer 42 (in particular, the resistive heating layers 42 disposed in the heat generating region 44).

### (1) First Modified Example

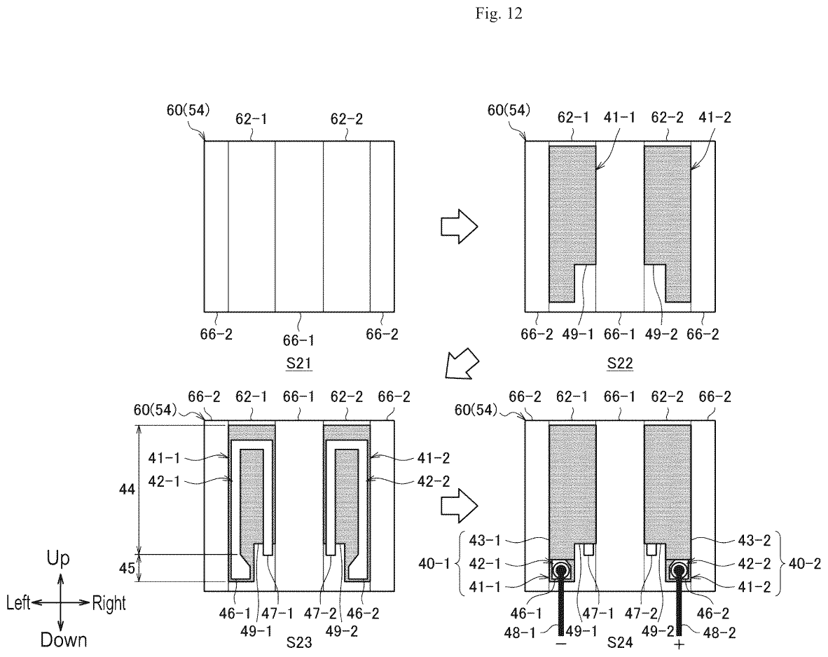

In the above embodiment, an example was described in which the second end portions 47 of the resistive heating layers 42 are connected to the non-pressing portion 66, but the present disclosure is not limited to such an example. The second end portions 47 of the resistive heating layers 42 may be connected to the pressing portion 62. Such a modified example will be described with reference to FIG. 12.

FIG. 12 is a diagram illustrating an example of the steps for manufacturing the heating system 30 according to the present modified example. The steps for manufacturing the heating system 30 according to the present modified example include manufacturing steps S21 to S24 illustrated in FIG. 12 instead of manufacturing steps S11 to S14 of FIG. 9. In the following, points of difference from manufacturing steps S11 to S14 will mainly be described, and descriptions of similar points will be omitted.

Manufacturing step S21 of FIG. 12 is the same as manufacturing step S11 of FIG. 9.

In manufacturing step S22 of FIG. 12, the first electrically insulating layers 41 are laminated onto the pressing portions 62. However, in the present modified example, a cutout 49-1 is provided in a lower portion of the first electrically insulating layer 41-1, exposing a portion of the pressing portion 62-1. Similarly, a cutout 49-2 is provided in a lower portion of the first electrically insulating layer 41-2, exposing a portion of the pressing portion 62-2.

In manufacturing step S23 of FIG. 12, the resistive heating layers 42 are laminated onto the outer sides of the first electrically insulating layers 41 laminated onto the pressing portions 62 of the partially manufactured heating system 30 that has passed through manufacturing step S22. However, in the present modified example, the second end portion 47-1 of the resistive heating layer 42-1 that protrudes from the first electrically insulating layer 41-1 is connected to the pressing portion 62-1 exposed in the cutout 49-1 of the first electrically insulating layer 41-1. Similarly, the second end portion 47-2 of the resistive heating layer 42-2 that protrudes from the first electrically insulating layer 41-2 is connected to the pressing portion 62-2 exposed in the cutout 49-2 of the first electrically insulating layer 41-1. With this configuration, it is possible for the resistive heating layers 42 to be laminated only onto the outer sides of the flat pressing portions 62. The occurrence of defects such as misalignment and peeling of the resistive heating layers 42 can therefore be prevented more effectively than in a case in which the second end portions 47 of the resistive heating layers 42 are connected to the curved non-pressing portions 66.

In manufacturing step S24 of FIG. 12, the second electrically insulating layers 43 are laminated onto the outer sides of the first electrically insulating layers 41 and the resistive heating layers 42 laminated onto the pressing portions 62 of the partially manufactured heating system 30 that has passed through manufacturing step S23. However, in the present modified example, a cutout 49-1 is also provided in a lower portion of the second electrically insulating layer 43-1, in the same manner as in the first electrically insulating layer 41-1. Similarly, a cutout 49-2 is also provided in a lower portion of the second electrically insulating layer 43-2, in the same manner as in the first electrically insulating layer 41-2.

Further, in manufacturing step S24, the conducting wire 48-1 is connected to the resistive heating layer 42-1 and the conducting wire 48-2 is connected to the resistive heating layer 42-2.

### (2) Second Modified Example

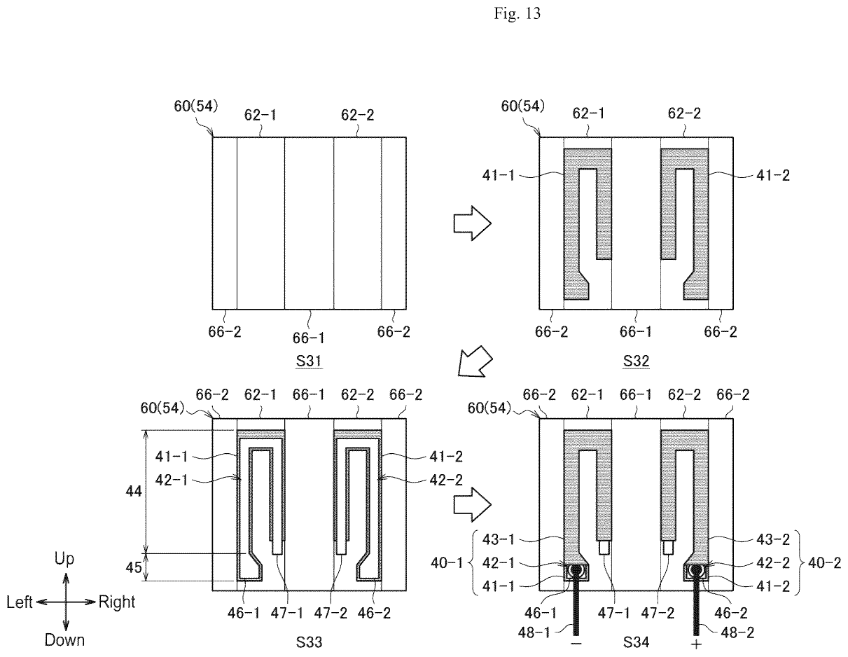

The first electrically insulating layers 41 and the second electrically insulating layers 43 may have any shape, provided that they are shaped to cover the resistive heating layers 42 in such a way as to sandwich the same from both sides. In the following, as a second modified example, another example of the shape that the first electrically insulating layers 41 and the second electrically insulating layers 43 may take is described with reference to FIG. 13. In the following, the second modified example is described as a further modified example of the first modified example.

FIG. 13 is a diagram illustrating an example of the steps for manufacturing the heating system 30 according to the present modified example. The steps for manufacturing the heating system 30 according to the present modified example include manufacturing steps S31 to S34 illustrated in FIG. 13 instead of manufacturing steps S21 to S24 of FIG. 12. In the following, points of difference from manufacturing steps S21 to S24 will mainly be described, and descriptions of similar points will be omitted.

Manufacturing step S31 of FIG. 13 is the same as manufacturing step S11 of FIG. 9.

In manufacturing step S32 of FIG. 13, the first electrically insulating layers 41 are laminated onto the pressing portions 62. However, in the present modified example, the first electrically insulating layer 41-1 has a shape that conforms to the resistive heating layer 42-1 to be laminated later. That is, the first electrically insulating layer 41-1 is laminated onto the pressing portion 62-1 in the shape of a single line that moves back and forth in the up-down direction while leaving a gap in the left-right direction. Similarly, the first electrically insulating layer 41-2 has a shape that conforms to the resistive heating layer 42-2 to be laminated later. That is, the first electrically insulating layer 41-2 is laminated onto the pressing portion 62-2 in the shape of a single line that moves back and forth in the up-down direction while leaving a gap in the left-right direction.

In manufacturing step S33 of FIG. 13, in the same manner as in manufacturing step S23 of FIG. 12, the resistive heating layers 42 are laminated onto the outer sides of the first electrically insulating layers 41 laminated onto the pressing portions 62 of the partially manufactured heating system 30 that has passed through manufacturing step S32.

In manufacturing step S34 of FIG. 13, the second electrically insulating layers 43 are laminated onto the outer sides of the first electrically insulating layers 41 and the resistive heating layers 42 laminated onto the pressing portions 62 of the partially manufactured heating system 30 that has passed through manufacturing step S33. However, in the present modified example, the second electrically insulating layer 43-1 has a similar shape to the first electrically insulating layer 41-1. Similarly, the second electrically insulating layer 43-2 has a similar shape to the first electrically insulating layer 41-2.

Further, in manufacturing step S34, the conducting wire 48-1 is connected to the resistive heating layer 42-1 and the conducting wire 48-2 is connected to the resistive heating layer 42-2.

As described hereinabove, the first electrically insulating layers 41 and the second electrically insulating layers 43 according to the present modified example are in the shape of a single line that moves back and forth in the up-down direction while leaving a gap in the left-right direction. Therefore, if a heat diffusion layer is laminated onto the outer sides of the heating units 40 and the measuring units 90, the heat diffusion layer comes into direct contact with the pressing portions 62 exposed in the left-right direction gaps in the first electrically insulating layer 41 and the second electrically insulating layer 43. Consequently, the thermal diffusion effect of the heat diffusion layer can also be exhibited with respect to the pressing portions 62, enabling a further improvement in the heating efficiency.

### (3) Third Modified Example

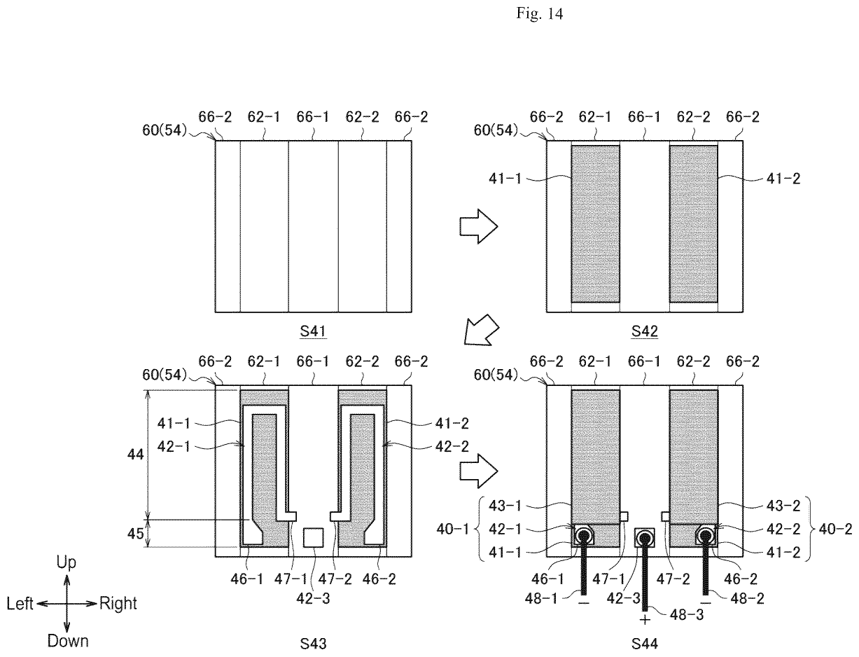

Although an example in which the resistive heating layer 42-1 and the resistive heating layer 42-2 form one series circuit has been described above, the present disclosure is not limited to such an example. The resistive heating layer 42-1 and the resistive heating layer 42-2 may form a parallel circuit. Such a modified example will be described with reference to FIG. 14.

FIG. 14 is a diagram illustrating an example of the steps for manufacturing the heating system 30 according to the present modified example. The steps for manufacturing the heating system 30 according to the present modified example include manufacturing steps S41 to S44 illustrated in FIG. 14 instead of manufacturing steps S11 to S14 of FIG. 9. In the following, points of difference from manufacturing steps S11 to S14 will mainly be described, and descriptions of similar points will be omitted.

Manufacturing step S41 of FIG. 14 is the same as manufacturing step S11 of FIG. 9.

Manufacturing step S42 of FIG. 14 is the same as manufacturing step S12 of FIG. 9.

In manufacturing step S43 of FIG. 14, in the same manner as in manufacturing step S13 of FIG. 9, the resistive heating layers 42-1 and 42-2 are laminated onto the outer sides of the first electrically insulating layers 41-1 and 41-2 laminated onto the pressing portions 62 of the partially manufactured heating system 30 that has passed through manufacturing step S42.

In addition, in the present modified example, in manufacturing step S43 a rectangular resistive heating layer 42-3 is laminated onto a lower portion of the non-pressing portion 66-1. The resistive heating layer 42-3 is laminated in the non-heat generating region 45. That is, the resistive heating layer 42-3 is configured to be wide, similar to the first end portion 46-1 of the resistive heating layer 42-1 and the first end portion 46-2 of the resistive heating layer 42-2. This makes it possible to prevent the generation of heat in the resistive heating layer 42-3 and to prevent the transfer of heat to the conducting wires 48, and also to prevent the connecting parts between the conducting wires 48 and the resistive heating layers 42 from being damaged by heat.

In manufacturing step S44 of FIG. 14, the second electrically insulating layers 43 are laminated onto the outer sides of the first electrically insulating layers 41 and the resistive heating layers 42 laminated onto the pressing portions 62 of the partially manufactured heating system 30 that has passed through manufacturing step S43, in the same manner as in manufacturing step S14 of FIG. 9.

Further, in manufacturing step S44, the conducting wire 48-1 is connected to the resistive heating layer 42-1 and the conducting wire 48-2 is connected to the resistive heating layer 42-2, in the same manner as in manufacturing step S14 of FIG. 9. However, the conducting wire 48-1 and the conducting wire 48-2 are each connected to the negative electrode of the power source unit 111.

In addition, in the present modified example, in manufacturing step 44 a conducting wire 48-3 is connected to the resistive heating layer 42-3. The conducting wire 48-3 is connected to the positive electrode of the power source unit 111. As a result, the conducting wire 48-3 connected to the power source unit 111 is connected to the accommodating portion 50. Then, the second end portion 47-1 of the resistive heating layer 42-1 is electrically connected via the accommodating portion 50 to the conducting wire 48-3 connected to the accommodating portion 50 (more precisely, to the resistive heating layer 42-3). Therefore, the conducting wire 48-1, the resistive heating layer 42-1, the accommodating portion 50, the resistive heating layer 42-3, and the conducting wire 48-3 form a first circuit connected to the power source unit 111. Meanwhile, the second end portion 47-2 of the resistive heating layer 42-2 is electrically connected via the accommodating portion 50 to the conducting wire 48-3 connected to the accommodating portion 50 (more precisely, to the resistive heating layer 42-3). Therefore, the conducting wire 48-2, the resistive heating layer 42-2, the accommodating portion 50, the resistive heating layer 42-3, and the conducting wire 48-3 form a second circuit connected to the power source unit 111. The first circuit and second circuit described above constitute one parallel circuit. When the power source unit 111 supplies electric power to this parallel circuit, heat can be generated in the resistive heating layer 42-1 and the resistive heating layer 42-2.

### (4) Fourth Modified Example

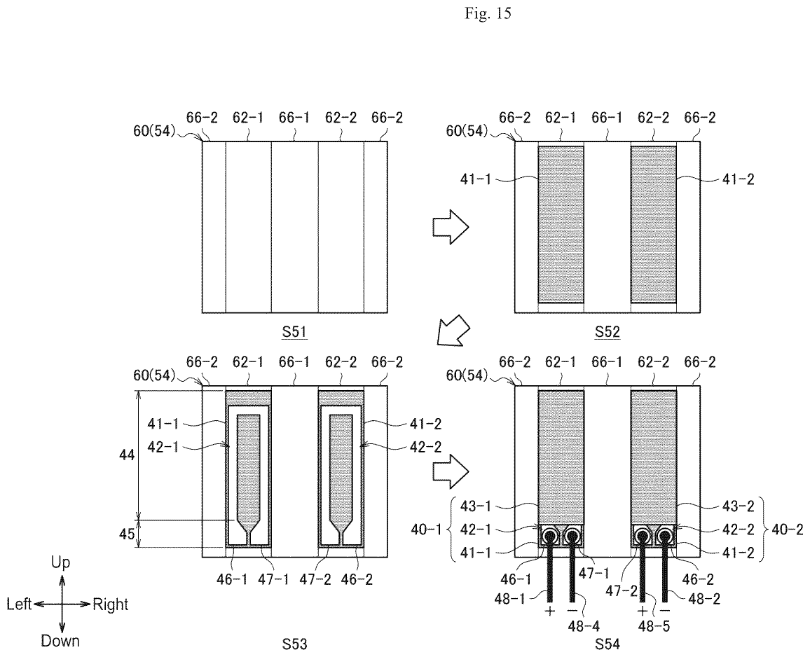

Although examples in which the resistive heating layers 42 are connected to the power source unit via the accommodating portion 50 have been described above, the present disclosure is not limited to such examples. The resistive heating layers 42 may be connected to the power source unit 111 without the passing through the accommodating portion 50. Such a modified example will be described with reference to FIG. 15.

FIG. 15 is a diagram illustrating an example of the steps for manufacturing the heating system 30 according to the present modified example. The steps for manufacturing the heating system 30 according to the present modified example include manufacturing steps S51 to S54 illustrated in FIG. 15 instead of manufacturing steps S11 to S14 of FIG. 9. In the following, points of difference from manufacturing steps S11 to S14 will mainly be described, and descriptions of similar points will be omitted.

Manufacturing step S51 of FIG. 15 is the same as manufacturing step S11 of FIG. 9.

Manufacturing step S52 of FIG. 15 is the same as manufacturing step S12 of FIG. 9.

In manufacturing step S53 of FIG. 15, the resistive heating layers 42 are laminated onto the outer sides of the first electrically insulating layers 41 laminated onto the pressing portions 62 of the partially manufactured heating system 30 that has passed through manufacturing step S52. However, in the present modified example, both the first end portions 46 and the second end portions 47, which are the two ends of each of the resistive heating layers 42, are disposed within the first electrically insulating layer 41. In particular, the first end portions 46 and the second end portions 47 are disposed on lower end portions of the first electrically insulating layers 41.

In manufacturing step S54 of FIG. 15, the second electrically insulating layers 43 are laminated onto the outer sides of the first electrically insulating layers 41 and the resistive heating layers 42 laminated onto the pressing portions 62 of the partially manufactured heating system 30 that has passed through manufacturing step S53, in the same manner as in manufacturing step S14 of FIG. 9.

Furthermore, in the present modified example, in manufacturing step S54 the conducting wires 48 connected to the power source unit 111 are connected to each of the first end portions 46 and the second end portions 47 of the resistive heating layers 42. Specifically, the conducting wire 48-1 connected to the positive electrode of the power source unit 111 is connected to the first end portion 46-1 of the resistive heating layer 42-1. A conducting wire 48-4 connected to the negative electrode of the power source unit 111 is connected to the second end portion 47-1 of the resistive heating layer 42-1. Therefore, the conducting wire 48-1, the resistive heating layer 42-1 and the conducting wire 48-4 form a first circuit connected to the power source unit 111. Meanwhile, the conducting wire 48-2 connected to the negative electrode of the power source unit 111 is connected to the first end portion 46-2 of the resistive heating layer 42-2. A conducting wire 48-5 connected to the positive electrode of the power source unit 111 is connected to the second end portion 47-2 of the resistive heating layer 42-2. Therefore, the conducting wire 48-2, the resistive heating layer 42-2 and the conducting wire 48-5 form a second circuit connected to the power source unit 111. The first circuit and second circuit described above constitute one parallel circuit. When the power source unit 111 supplies electric power to this parallel circuit, heat can be generated in the resistive heating layer 42-1 and the resistive heating layer 42-2.

It should be noted that the operations of the first circuit and the second circuit constituting the parallel circuit may be controlled individually or collectively. That is, the first circuit and the second circuit may be supplied with different powers or may be supplied with the same power.

### <5. Heating Control>

### (1) Heating Profile

The control unit 116 controls the operation of the heating units 40 on the basis of a heating profile. Control of the operation of the heating units 40 is achieved by controlling the supply of electric power from the power source unit 111 to the heating units 40. The heating units 40 use the electric power supplied from the power source unit 111 to heat the stick-shaped substrate 150.

The heating profile is control information for controlling the temperature to which the aerosol source is heated. The heating profile may be control information for controlling the temperature of the heating units 40 (i.e. the temperature of the resistive heating layers 42 measured using the measuring units 90). As an example, the heating profile may include a target value (also referred hereinafter as the target temperature) of the temperature to which the aerosol source is heated. The target temperature may vary depending on the elapsed time since the start of heating, in which case the heating profile includes information defining a time series transition of the target temperature. As another example, the heating profile may include parameters (hereinafter also referred to as power supply parameters) defining a method for supplying electric power to the heating units 40. The power supply parameters include, for example, the voltage applied to the heating units 40, ON/OFF of the power supply to the heating units 40, or the feedback control method to be employed. Turning the power supply to the heating units 40 on/off may be regarded as turning the heating units 40 on/off.

The control unit 116 controls the operation of the heating units 40 such that the temperature of the heating units 40 transitions in the same manner as the target temperature defined in the heating profile. The heating profile is typically designed to optimize the flavor tasted by the user when the user inhales the aerosol generated from the stick-shaped substrate 150. Therefore, the flavor tasted by the user can be optimized by controlling the operation of the heating units 40 on the basis of the heating profile.

The temperature control of the heating units 40 can, for example, be achieved by known feedback control. The feedback control may, for example, be proportional-integral-differential (PID) control. The control unit 116 may cause electric power from the power source unit 111 to be supplied to the heating units 40 in the form of pulses obtained by pulse width modulation (PWM) or pulse frequency modulation (PFM). In this case, the control unit 116 can control the temperature of the heating units 40 by adjusting the pulse width or the frequency of the electric power pulses to control the duty ratio in the feedback control. Alternatively, the control unit 116 may perform simple on/off control in the feedback control. For example, the control unit 116 may perform heating by means of the heating units 40 until the temperature of the heating units 40 reaches the target temperature. The control unit 116 may then interrupt heating by means of the heating units 40 when the temperature of the heating units 40 reaches the target temperature and resume heating by means of the heating units 40 when the temperature of the heating units 40 falls below the target temperature.

The period from the beginning to the end of the processing for generating the aerosol using the stick-shaped substrate 150 is also referred to hereinafter as a heating session. In other words, a heating session is a period of time during which the operation of the heating units 40 is controlled on the basis of the heating profile. The beginning of the heating session is the timing at which heating based on the heating profile begins. The end of the heating session is the timing at which a sufficient amount of aerosol is no longer generated. The heating session comprises a pre-heating period and a puffable period following the pre-heating period. The puffable period is a period during which a sufficient amount of aerosol is expected to be generated. The pre-heating period is a period from when heating begins until the puffable period begins. Heating performed in the pre-heating period is also referred to as pre-heating.
First example of heating profile

An example of a heating profile is shown in Table 1 below.

TABLE 1
Example of heating profile

| Period | | | Time series transition | Time series transition |
|---|---|---|---|---|
| Name | Category | Duration | of target temperature | of power supply parameter |
| Initial temperature- | STEP 0 | — | Increase to 295° C. | ON |
| increase period | | | (no time control) | |
| | STEP 1 | 20 sec. | Maintain 295° C. | ON |
| | STEP 2 | 20 sec. | Maintain 295° C. | ON |
| Intermediate | STEP 3 | — | Decrease to 230° C. | OFF |
| temperature- | | | (no time control) | |
| decrease period | | | | |
| Temperature re- | STEP 4 | 40 sec. | Maintain 230° C. | ON |
| increase period | STEP 5 | 40 sec. | Increase to 260° C. | ON |
| | STEP 6 | 40 sec. | Maintain 260° C. | ON |
| Heating end period | STEP 7 | 20 sec. | — | OFF |

As shown in Table 1, the heating profile may be divided into a plurality of periods, each period defining a time series transition of the target temperature and a time series transition of the power supply parameters. In the example shown in Table 1, the heating profile is divided into a total of eight periods, namely step 0 to step 7. In each step, the time series transition of the target temperature and the time series transition of the power supply parameters are defined.

As shown in Table 1, the heating profile comprises information for controlling the temperature of the heating units 40 in each of an initial temperature-increase period, an intermediate temperature-decrease period, a temperature re-increase period, and a heating end period. The initial temperature-increase period is a period during which the temperature of the heating units 40 is increased from a prescribed temperature or is maintained, and is an example of a first period. The initial temperature-increase period consists of step 0 to step 2. The intermediate temperature-decrease period follows the initial temperature-increase period and is a period during which the temperature of the heating units 40 decreases, and is an example of a second period. The intermediate temperature-decrease period consists of step 3. The temperature re-increase period is follows the intermediate temperature-decrease period, and is a period during which the temperature of the heating units 40 is increased or maintained, and is an example of a third period. The temperature re-increase period consists of step 4 to step 6. The heating end period follows the temperature re-increase period, and is a period during which the temperature of the heating units 40 decreases. The heating end period consists of step 7. Configuring the heating session to comprise, in the stated order, the initial temperature-increase period, the intermediate temperature-decrease period, and the temperature re-increase period, makes it possible to shorten the pre-heating period, prevent rapid consumption of the aerosol source, and optimize the smoke flavor delivered to the user, as discussed hereinbelow.

In each step, time control may be implemented. Time control is control in which the ending of the step is triggered by the elapse of a prescribed time (i.e. the duration set for each step). It should be noted that when time control is implemented, the rate of change in the temperature of the heating units 40 may be controlled such that the temperature of the heating units 40 reaches the target temperature at the end of the duration. Alternatively, the target temperature may be considered to change gradually over the entire step. Furthermore, if time control is implemented, the temperature of the heating units 40 may be controlled such that the temperature of the heating units 40 reaches the target temperature midway through the duration and thereafter the temperature of the heating units 40 is maintained at the target temperature until the duration elapses. In the example shown in Table 1 above, time control is performed in steps 1, 2 and 4 to 7.

In some cases, time control is not implemented in any step. If time control is not performed, the ending of the step is triggered when the temperature of the heating units 40 has reached a prescribed temperature (i.e. the target temperature set for each step). As such, the duration of a step in which time control is not implemented increases or decreases depending on the rate of temperature change. In the example shown in Table 1 above, time control is not performed in steps 0 and 3.

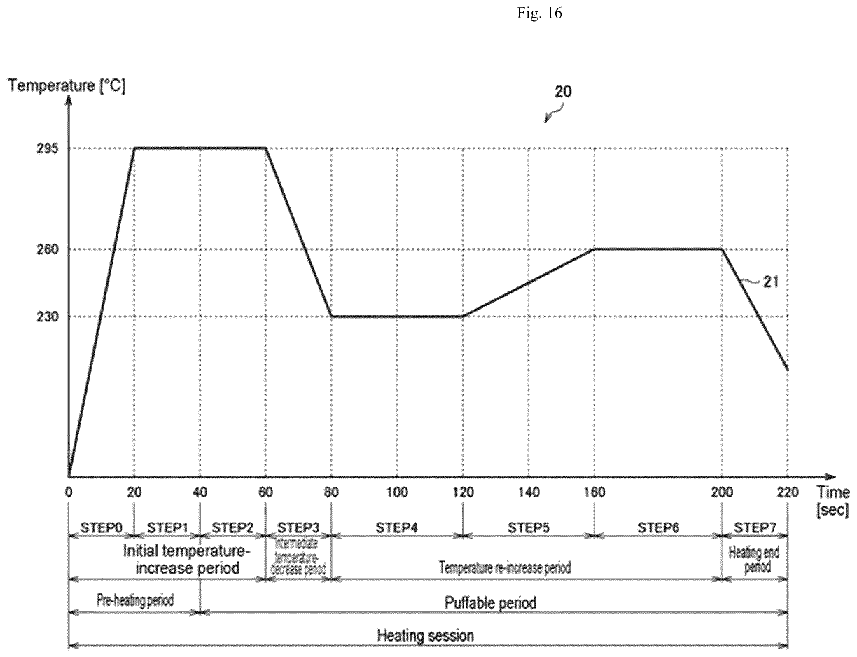

The transition of the temperature of the heating units 40 when the control unit 116 performs temperature control in accordance with the heating profile shown in Table 1 will be described with reference to FIG. 16. FIG. 16 is a graph illustrating an example of the transition in the temperature of heating units 40 when temperature control is performed on the basis of the heating profile shown in Table 1. The horizontal axis of graph 20 is time in seconds. The vertical axis of graph 20 is the temperature of the heating units 40. Line 21 indicates the transition of the temperature of the heating units 40. As shown in FIG. 16, the temperature of the heating units 40 transitions in the same manner as the transition of the target temperature defined in the heating profile. An example of a heating profile will now be described with reference to Table 1 and FIG. 16.

As shown in Table 1 and FIG. 16, in step 0, the temperature of the heating units 40 increases from an initial temperature to 295° C. The initial temperature is the temperature of the heating units 40 at the beginning of heating. In step 0, time control is not implemented. As such, step 0 ends with the temperature of the heating units 40 reaching 295° C. as the trigger. In the example shown in FIG. 16, step 0 ends after 20 seconds. Thereafter, in steps 1 and 2, the temperature of the heating units 40 is maintained at 295° C. The pre-heating period ends at the end of step 1, and the puffable period begins together with the start of step 2.

A shorter pre-heating time is desirable for the user. However, if the stick-shaped substrate 150 is not sufficiently heated, moisture may not evaporate fully inside the stick substrate 150 and remain therein. If the user then takes a puff, hot water vapor may be delivered to the user's mouth. As such, it is desirable to increase the temperature of the heating units 40 rapidly in step 0 until it reaches 295° C. and to ensure a certain duration for steps 1 and 2.

As shown in Table 1 and FIG. 16, in step 3, the temperature of the heating units 40 decreases to 230° C. Time control is not implemented in step 3. As such, step 3 ends with the temperature of the heating units 40 reaching 230° C. as the trigger. In the example shown in FIG. 16, step 3 ends after 20 seconds. In step 2, the power supply to the heating units 40 is turned off. As a result, the temperature of the heating units 40 can be reduced at the maximum rate. Reducing the temperature of the heating units 40 during the heating session in this way can prevent rapid consumption of the aerosol source. As a result, it is possible to prevent the aerosol source from becoming depleted during the heating session.

As shown in Table 1 and FIG. 16, next, from step 4 to step 6, the temperature of the heating units 40 increases stepwise to 260° C. In this way, gradually increasing the temperature of the heating units 40 makes it possible to reduce power consumption over the entire heating session while maintaining an amount of aerosol generation.

As shown in Table 1 and FIG. 16, in step 7, the temperature of the heating units 40 decreases. In step 7, the power supply to the heating units 40 is turned off. In step 7, the duration is specified, but the target temperature is not specified. Thus, step 7 ends with the end of the duration as the trigger. In step 7, a sufficient amount of aerosol may be generated due to the residual heat in the stick-shaped substrate 150. Consequently, in this example, the puffable period, i.e. the heating session, ends together with the end of step 7.

The notifying unit 113 may notify the user of information indicating the timing at which the pre-heating ends. For example, the notification unit 113 notifies the user of information announcing the end of the pre-heating period before the pre-heating period ends, or notifies the user of information indicating that the pre-heating has ended at the timing at which the pre-heating has ended. The notification to the user may be issued by lighting an LED or by means of vibrations, for example. By referring to such a notification, the user is able to take a puff immediately after the end of the pre-heating.

Similarly, the notifying unit 113 may notify the user of information indicating the timing at which the puffable period ends. For example, the notification unit 113 notifies the user of information announcing the end of the puffable period before the puffable period ends, or notifies the user of information indicating that the puffable period has ended at the timing at which the puffable period has ended. The notification to the user may be issued by lighting an LED or by means of vibrations, for example. By referring to such a notification, the user is able to take puffs until the end of the puffable period.

It should be noted that the heating profile described above is only an example, and various other examples are conceivable. As an example, the number of steps, the duration of each step, and the target temperature may be modified accordingly.
Second example of heating profile

An example of a heating profile is shown in Table 2 below.

TABLE 2
Example of heating profile

| Period | | | Time series transition | Time series transition |
|---|---|---|---|---|
| Name | Category | Duration | of target temperature | of power supply parameter |
| Initial temperature- | STEP 0 | — | Increase to 295° C. | ON |
| increase period | | | (no time control) | |
| | STEP 1 | 20 sec. | Maintain 295° C. | ON |
| | STEP 2 | 20 sec. | Maintain 295° C. | ON |
| Intermediate | STEP 3 | 20 sec. | Decrease to 275° C. | OFF |
| temperature- | STEP 4 | 20 sec. | Decrease to 255° C. | (ON after reaching |
| decrease period | STEP 6 | 20 sec. | Decrease to 230° C. | target temperature) |
| Temperature re- | STEP 6 | 40 sec. | Increase to 260° C. | ON |
| increase period | STEP 7 | 40 sec. | Maintain 260° C. | ON |
| Heating end period | STEP 8 | 20 sec. | — | OFF |

Similar to the heating profile shown in Table 1, the heating profile shown in Table 2 comprises information for controlling the temperature of the heating units 40 in each of the initial temperature-increase period, the intermediate temperature-decrease period, the temperature re-increase period, and the heating end period. The differences between the heating profile shown in Table 2 and the heating profile shown in Table 1 will now mainly be explained.

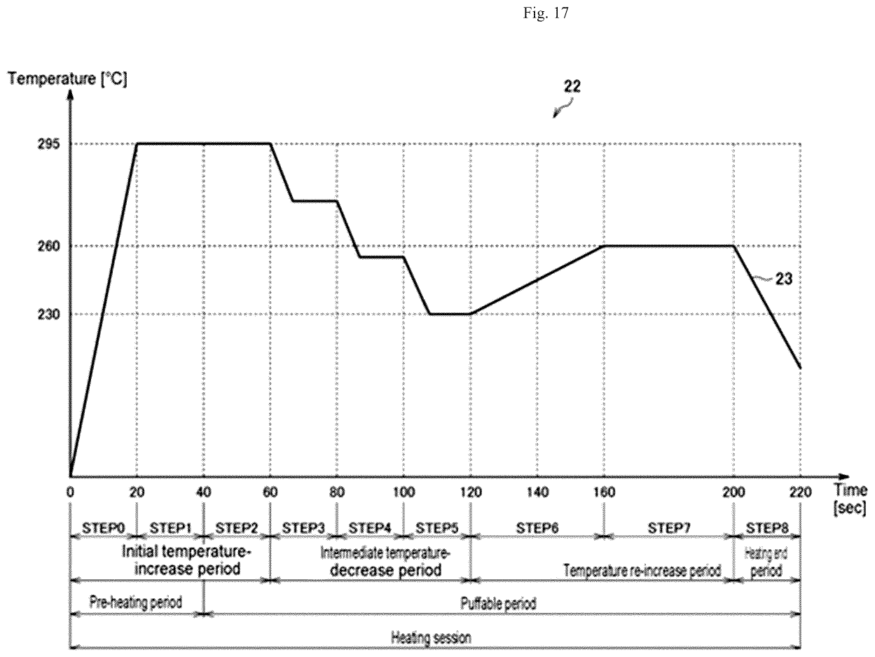

The heating profile shown in Table 2 differs from the heating profile shown in Table 1 in that the temperature of the heating units 40 decreases stepwise during the intermediate temperature-decrease period. That is, in the heating profile shown in Table 2, the intermediate temperature-decrease period follows the initial temperature-increase period and is a period during which the temperature of the heating units 40 decreases or is maintained. The intermediate temperature-decrease period of the heating profile shown in Table 2 consists of steps 3 to 5. The temperature transition during the intermediate temperature-decrease period will be described in detail with reference to FIG. 17. FIG. 17 is a graph illustrating an example of the transition in temperature of the heating units 40 when temperature control is performed on the basis of the heating profile shown in Table 2. The horizontal axis of graph 22 is time in seconds. The vertical axis of graph 22 is the temperature of the heating units 40. Line 23 represents the transition in the temperature of the heating units 40. As shown in FIG. 17, the temperature of the heating units 40 transitions in the same manner as the transition of the target temperature defined in the heating profile.

As shown in Table 2 and FIG. 17, in step 3 the temperature of the heating units 40 decreases to 275° C. Time control is implemented in step 3. Consequently, after the temperature of the heating units 40 has decreased to 275° C., step 3 continues until the duration of step 3 expires. In step 3, the power supply to the heating units 40 is turned off until the temperature of the heating units 40 decreases to 275° C., after which the power supply to the heating units 40 is turned on and the temperature of the heating units 40 is maintained at 275° C.

As shown in Table 2 and FIG. 17, in step 4, the temperature of the heating units 40 decreases to 255° C. Time control is implemented in step 4. Consequently, after the temperature of the heating units 40 has decreased to 275° C., step 4 continues until the duration of step 4 expires. In step 4, the power supply to the heating units 40 is turned off until the temperature of the heating units 40 decreases to 255° C., after which the power supply to the heating units 40 is turned on and the temperature of the heating units 40 is maintained at 255° C.

As shown in Table 2 and FIG. 17, in step 5, the temperature of the heating units 40 decreases to 230° C. Time control is implemented in step 5. Consequently, after the temperature of the heating units 40 has decreased to 230° C., step 5 continues until the duration of step 5 expires. In step 5, the power supply to the heating units 40 is turned off until the temperature of the heating units 40 decreases to 230° C., after which the power supply to the heating units 40 is turned on and the temperature of the heating units 40 is maintained at 230° C.

Reducing the temperature of the heating units 40 in a stepwise manner during the intermediate temperature-decrease period in this way makes it possible to prevent a sudden decrease in the temperature of the heating units 40. As a result, it is possible to prevent inconveniences such as a sudden decrease in the amount of aerosol, which leads to deterioration of the smoke flavor.

### (2) Temperature Control

The control unit 116 controls the temperature of the heating units 40 by controlling the supply of power to the heating units 40. More specifically, the control unit 116 controls the temperature of the resistive heating layers 42 by controlling the supply of power to the resistive heating layers 42 on the basis of the heating profile.

In particular, the control unit 116 controls the supply of power to the resistive heating layers 42 on the basis of the resistance of the electrically conductive layers 91. It should be noted that the control unit 116 calculates the temperature of the heating units 42 on the basis of the electrical resistance values of the electrically conductive layers 91. As an example, the control unit 116 measures the temperature of the electrically conductive layers 91 on the basis of the electrical resistance of the electrically conductive layers 91 and the temperature coefficient of resistance of the electrically conductive layers 91, and measures (for example, estimates) the temperature of the electrically conductive layers 91 as the temperature of the resistive heating layers 42. As described above, the temperature of the electrically conductive layers 91 is considered to match or substantially match the temperature of the resistive heating layers 42. Then, the control unit 116 controls the supply of power to the resistive heating layers 42 on the basis of the temperature of the resistive heating layers 42 measured on the basis of the resistance of the electrically conductive layers 91.

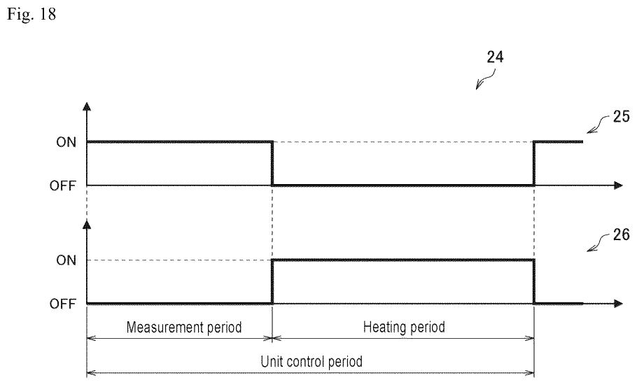

The control unit 116 may repeat, in the stated order, a first step for applying a voltage to the electrically conductive layers 91 to measure the electrical resistance of the electrically conductive layers 91, and a second step for applying a voltage to the resistive heating layers 42 in a manner determined on the basis of the electrical resistance of the electrically conductive layers 91 measured in the first step. More specifically, in the first step, the control unit 116 applies a voltage to the electrically conductive layers 91, measures the electrical resistance value of the electrically conductive layers 91, and measures the temperature of the resistive heating layers 42 on the basis of the measured electrical resistance value of the electrically conductive layers 91. Then, as the manner for applying the voltage to the resistive heating layers 42 in the second step, the control unit 116 determines the duty ratio of the voltage applied to the resistive heating layers 42 in the second step, on the basis of the measured temperature of the resistive heating layers 42 and the target temperature defined in the heating profile. Then, in the second step following the first step, the control unit 116 controls the power supply unit 111 to apply a voltage having a pulse width or frequency corresponding to the determined duty ratio to the resistive heating layers 42. The control unit 116 repeatedly executes a control block consisting of the first step and the second step. Such a configuration allows the temperature of the resistive heating layers 42 to be transitioned as defined in the heating profile. In the following, unless otherwise mentioned, the temperature of the resistive heating layers 42 is measured on the basis of the electrical resistance value of the electrically conductive layers 91 measured in the first step. The control block is described in detail with reference to FIG. 18.

FIG. 18 is a graph used to describe the temperature control of the resistive heating layers 42 according to the present embodiment. Graph 24 shows ON/OFF of the voltage applied to each of the electrically conductive layers 91 and the resistive heating layers 42 in the control block. A unit control period is a period during which one control block is executed. The unit control period comprises, in the stated order, a measurement period, which is the period during which the first step is performed, and a heating period, which is the period during which the second step is performed. Graph 24 includes a graph 25 and a graph 26. Graph 25 shows ON/OFF of the application of the voltage to the electrically conductive layers 91 in the first step. Graph 26 shows ON/OFF of the application of the voltage to the resistive heating layers 42 in the second step.

As shown in FIG. 18, the control unit 116 may cause the period during which the first step is performed and the period during which the second step is performed to differ. That is, the period during which a voltage is applied to the electrically conductive layers 91 may differ from the period during which a voltage is applied to the resistive heating layers 42. Such switching of the voltage application destination may be achieved using a field effect transistor (FET) or the like. With this configuration, since a voltage is prevented from being applied simultaneously to both the electrically conductive layers 91 and the resistive heating layers 42, it is possible to reduce the load on the control unit 116

It should be noted that the voltage applied to the electrically conductive layers 91 in the measurement period may be weak compared to the voltage applied to the resistive heating layers 42 in the heating period. Furthermore, the duty ratio in the measurement period may be set to a low value, such as 1%. As a result, it is possible to prevent the temperature of the electrically conductive layers 91 being increased during the measurement period. That is, it is possible to maintain a state in which the temperature of the electrically conductive layers 91 and the temperature of the resistive heating layers 42 are the same or substantially the same.

### <3. Processing Flow>

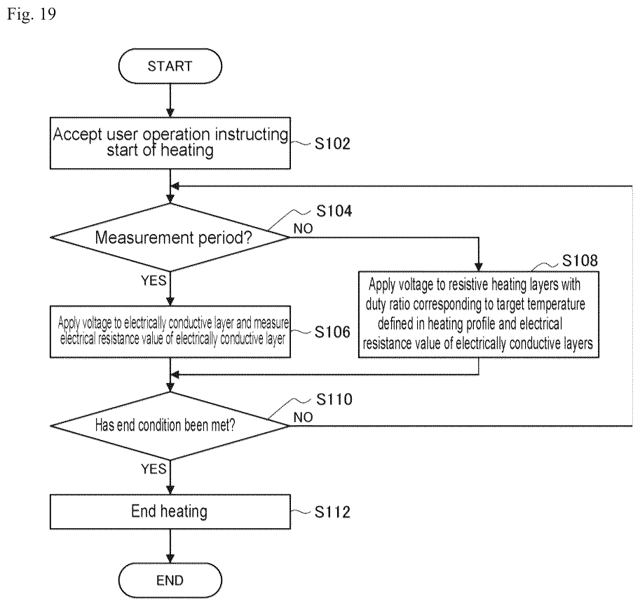

An example of the processing flow executed in the inhalation device 100 according to the present embodiment will now be described with reference to FIG. 19. FIG. 19 is a flowchart illustrating an example of a processing flow executed in the inhalation device 100 according to the present embodiment.

As shown in FIG. 19, first, the sensor unit 112 accepts a user operation for instructing the start of heating (step S102). An example of a user operation for instructing the start of heating is an operation performed with respect to the inhalation device 100, such as operating a switch, etc. provided in the inhalation device 100. Another example of a user operation for instructing the start of heating is to insert a stick-shaped substrate 150 into the inhalation device 100.

The control unit 116 then determines whether the measurement period is ongoing (step S104). For example, the control unit 116 determines whether the elapsed time since the user operation instructing the start of heating was detected is included in the measurement period or the heating period.

If it is determined that the measurement period is ongoing (step S104: YES), the control unit 116 applies a voltage to the electrically conductive layers 91 and measures the electrical resistance value of the electrically conductive layers 91 (step S106).

Meanwhile, if it is determined that the heating period is ongoing (step S104: NO), the control unit 116 applies a voltage to the resistive heating layers 42 with a duty ratio corresponding to the target temperature defined in the heating profile and the electrical resistance of the electrically conductive layers 91 (step S108). For example, the control unit 116 measures the temperature of the electrically conductive layers 91 on the basis of the electrical resistance value of the electrically conductive layers 91 measured in the most recent step S106, and takes the measured temperature of the electrically conductive layers 91 as the temperature of the resistive heating layers 42. The control unit 116 then determines the duty ratio of the voltage to be applied to the resistive heating layers 42 such that the measured temperature of the resistive heating layers 42 transitions in the same manner as the time series transition of the target temperature defined in the heating profile. The control unit 116 then applies a voltage to the resistive heating layers 42 with the determined duty ratio.

Next, the control unit 116 determines whether an end condition has been met (step S110). An example of the end condition is that the heating session has ended. Another example of the end condition is that a prescribed number of puffs since the start of heating has been reached.

If it is determined that the end condition has not been met (step S110: NO), the processing returns to step S104.

Meanwhile, if it is determined that the end condition has been met (step S110: YES), the control unit 116 ends the heating based on the heating profile (step S112). The processing then ends.

### <6. Supplementary Information>

Although preferred embodiments of the present disclosure have been described in detail above with reference to the accompanying drawings, the present disclosure is not limited to such examples. It is obvious that a person having an ordinary level of knowledge in the technical field to which the present disclosure belongs could conceive of various modified examples or variations within the scope of the technical concepts set forth in the claims, and these modified examples and variations will naturally be understood to fall within the technical scope of the present disclosure.

Various methods are conceivable for manufacturing the accommodating portion 50 in the form of a tubular body. As an example, the accommodating portion 50 in the form of a tubular body may be formed by subjecting a sheet material to a drawing process. As another example, the accommodating portion 50 in the form of a tubular body may be formed by bending a sheet material and welding the joints. In the latter case, the heating units 40 may be laminated onto the sheet material. Then, the accommodating portion 50 with the heating units 40 laminated thereon may be formed by bending the sheet material with the heating units 40 laminated thereon and welding the joints.

Although examples in which the holding portion 60 has two pressing portions 62 and two non-pressing portions 66 have been described above, the present disclosure is not limited to such examples. For example, the holding portion 60 may have three or more pressing portions 62 and three or more non-pressing portions 66.

Although examples in which each of the first electrically insulating layers 41, the resistive heating layers 42 and the second electrically insulating layers 43 constituting the heating units 40 are laminated using a printing process or a vapor deposition process have been described above, the present disclosure is not limited to such examples. As an example, the first electrically insulating layers 41 and the second electrically insulating layers 43 may be laminated by applying or transferring a paste-like material. As another example, the resistive heating layers 42 may comprise a metal foil processed into a predetermined shape, and may be placed on the first electrically insulating layers 41. If the resistive heating layers 42 comprise a metal foil, the metal foil may be placed on a carrier tape, and the first electrically insulating layers 41 may be printed thereon, and then the resulting printed material may be collectively transferred to the accommodating portion 50. If the resistive heating layers 42 comprise a metal foil, the resistive heating layers 42 and the accommodating portion 50 may be electrically connected by welding. Alternatively, for example, the heating units 40 may be manufactured separately and affixed to the outer side of the accommodating portion 50. The same applies to the electrically conductive layers 91 and the third electrically insulating layers 94 constituting the measuring units 90.

Although examples in which the contact points (i.e., the first end portions 46) between the resistive heating layers 42 and the conducting wires 48 are located on the pressing portions 62 have been described above, the present disclosure is not limited to such examples. For example, the first electrically insulating layers 41 and the resistive heating layers 42 may be extended to the bottom wall 56 of the accommodating portion 50, and the conducting wires 48 may be directly or indirectly connected to the resistive heating layers 42 on the bottom wall 56 of the accommodating portion 50.

Although examples in which the stick-shaped substrate 150 includes the substrate portion 151 and the mouthpiece portion 152 have been described above, the present disclosure is not limited to such examples. The stick-shaped substrate 150 may include only the substrate portion 151. Then, the inhalation device 100 may include the mouthpiece portion 152. For example, the mouthpiece portion 152 may be removably attached to the opening 52 of the accommodating portion 50.

Two or more of the above embodiments and modified examples may be combined, as appropriate. As an example, the accommodating portion 50 may include four or more pressing portions 62, and any two types of heating unit 40 among the heating units 40 illustrated in FIG. 9 and FIG. 12 to FIG. 15 may be disposed on one accommodating portion 50. As another example, the measuring unit 90 illustrated in FIG. 10 may be disposed in some of the plurality of heating units 40, and the measuring unit 90 illustrated in FIG. 11 may be disposed in some other of the plurality of heating units 40.

Although examples in which the conducting wires 48 are connected to at least one of the two ends of each resistive heating layer 42 have been described above, the present disclosure is not limited to such examples. As an example, the accommodating portion 50 may have three or more pressing portions 62, and both ends of the resistive heating layer 42 disposed on the pressing portion 62 located at the center of the three pressing portions 62 may be connected to the accommodating portion 50. Then, resistive heating layers 42 having one end connected to the power source unit 111 may be disposed on each of the two pressing portions 62 adjacent to and on both sides thereof, and the three resistive heating layers 42 may constitute one series circuit. As another example, the accommodating portion 50 may include two pressing portions 62, resistive heating layers 42 having both ends connected to the accommodating portion 50 may be disposed on each of the two pressing portions 62, and conducting wires connected to the power source unit 111 may be connected to each of the two non-pressing portions 66. In this case, the two resistive heating layers 42 form a parallel circuit.

In the above description, examples were described in which the operation of the heating units 40 is controlled on the basis of the temperature of the heating units 40 measured by the measuring units 90, but the present disclosure is not limited to such examples. The operation of the heating unit 40 may be controlled on the basis of a parameter corresponding to the temperature of the heating units 40. Similarly, the heating profile may comprise target values for a parameter corresponding to the temperature of the heating units 40. Parameters that can be cited corresponding to the temperature of the heating units 40 include the electrical resistance value of the electrically conductive layers 91 or the temperature of the electrically conductive layers 91.

Although examples in which the electrically conductive layers 91 are made of a single metal have been described above, the present disclosure is not limited to such examples. The material constituting the electrically conductive layers 91 can be selected at will, provided that the temperature coefficient of resistance of the electrically conductive layers 91 is more stable than the temperature coefficient of resistance of the resistive heating layers 42. The electrically conductive layers 91 may, for example, be made of a non-metal such as a ceramic, or an alloy.

Although examples in which the measuring units 90 are laminated onto all of the heating units 40 have been described above, the present disclosure is not limited to such examples. It is sufficient for the measuring units 90 to be laminated onto at least one of the two or more heating units 40.

Furthermore, the processing described using flowcharts or sequence diagrams in the present description need not necessarily be implemented in the order depicted. Some processing steps may be implemented in parallel. Furthermore, additional processing steps may be employed and some processing steps may be omitted.

It should be noted that the series of processes performed by each device described in the present description may be realized by using software, hardware, and any combination of software and hardware. Programs constituting the software are stored in advance on a recording medium (more specifically, a non-transitory computer-readable storage medium) provided internally or externally to each device, for example. Then, when the programs are executed, for example, by a computer for controlling each device described in the present description, the programs are read into a RAM and executed by means of a processing circuit such as a CPU. The recording medium is, for example, a magnetic disk, an optical disk, a magneto-optical disk, or a flash memory, etc. Furthermore, the computer programs may be distributed via a network, for example, without the use of a recording medium. Furthermore, the computer may be an application-specific integrated circuit such as an ASIC, a general-purpose processor which executes functions by reading software programs, or a computer on a server used for cloud computing, etc. Furthermore, the series of processes performed by each device described in the present description may be processed in a distributed manner by multiple computers.

It should be noted that configurations such as the following also fall within the technical scope of the present disclosure.

(1)

An aerosol generation system comprising a tubular body that accommodates a substrate containing an aerosol source,
resistive heating layers that are laminated onto the outer side of a side wall of the tubular body, and
electrically conductive layers that are laminated so as to overlap at least portions of the resistive heating layers.
   (2)

The aerosol generation system according to (1), wherein the rate of variation, with respect to temperature, in the temperature coefficient of resistance of the electrically conductive layers is less than the rate of variation, with respect to temperature, in the temperature coefficient of resistance of the resistive heating layers.

(3)

The aerosol generation system according to (1) or (2), wherein the electrically conductive layers are made of a single metal, and
the resistive heating layers are made of an alloy.
   (4)

The aerosol generation system according to any one of (1) to (3), wherein the resistive heating layers have a first part which generates heat when a current flows and a second part which generates less heat than the first part, and
the electrically conductive layers are laminated so as to overlap at least portions of the first parts of the resistive heating layers.
   (5)

The aerosol generation system according to (4), wherein conducting wires connected to a power source unit that applies a voltage to the electrically conductive layers are connected to parts of the electrically conductive layers that do not overlap the first part.

(6)

The aerosol-generating system according to any one of (1) to (5), wherein the direction in which a current flows in the resistive heating layers and the direction in which a current flows in the parts of the electrically conductive layers that overlap the resistive heating layers coincide.

(7)

The aerosol-generating system according to any one of (1) to (6), further comprising a control unit that controls the supply of power to the resistive heating layers on the basis of an electrical resistance value of the electrically conductive layers.

(8)

The aerosol generation system according to (7), wherein the control unit repeats, in the stated order, a first step for applying a voltage to the electrically conductive layers to measure an electrical resistance value of the electrically conductive layers, and a second step for applying a voltage to the resistive heating layers in a manner determined on the basis of the electrical resistance value of the electrically conductive layers measured in the first step.

(9)

The aerosol generation system according to (8), wherein the control unit causes a period during which the first step is performed and a period during which the second step is performed to differ.

(10)

The aerosol-generating system according to any one of (7) to (9), wherein the control unit controls the manner in which the voltage is applied to the resistive heating layers on the basis of control information defining a time series transition of a target value of a parameter corresponding to the temperature of the resistive heating layers.

(11)

The aerosol generation system according to (10), wherein the period during which the supply of power to the resistive heating layers is controlled on the basis of the control information includes, in the stated order:
a first period during which the temperature of the resistive heating layers increases from an initial temperature or is maintained;
a second period, following the first period, during which the temperature of the resistive heating layers decreases or is maintained; and
a third period, following the second period, during which the temperature of the resistive heating layers increases or is maintained.
   (12)

The aerosol generation system according to (10), wherein the period during which the supply of power to the resistive heating layers is controlled on the basis of the control information includes, in the stated order:
a first period during which the temperature of the resistive heating layers increases from an initial temperature or is maintained;
a second period, following the first period, during which the temperature of the resistive heating layers decreases; and
a third period, following the second period, during which the temperature of the resistive heating layers increases or is maintained.
   (13)

The aerosol-generating system according to any one of (1) to (12), further comprising the substrate.

(14)

A control method executed by a computer that controls an aerosol generation system, wherein
the aerosol generation system comprises
a tubular body that accommodates a substrate containing an aerosol source,
resistive heating layers that are laminated onto the outer side of a side wall of the tubular body, and
electrically conductive layers that are laminated so as to overlap at least portions of the resistive heating layers,
wherein
the control method includes
controlling the supply of electric power to the resistive heating layers on the basis of an electrical resistance value of the electrically conductive layers.
   (15)

A program executed by a computer that controls an aerosol generation system, wherein the aerosol generation system comprises
a tubular body that accommodates a substrate containing an aerosol source,
resistive heating layers that are laminated onto the outer side of a side wall of the tubular body, and
electrically conductive layers that are laminated so as to overlap at least portions of the resistive heating layers,
wherein
the program causes the computer to function as
a control unit that controls the supply of electric power to the resistive heating layers on the basis of an electrical resistance value of the electrically conductive layers.

### REFERENCE SIGNS LIST

100 inhalation device
111 power source unit
112 sensor unit
113 notifying unit
114 storage unit
115 communication unit
116 control unit
150 stick-shaped substrate
151 substrate portion
152 mouthpiece portion
30 heating system
40 heating unit
41 first electrically insulating layer
42 resistive heating layer
43 second electrically insulating layer
44 heat generating region
45 non-heat generating region
46 first end portion
47 second end portion
48 conducting wire
49 cutout
50 accommodating portion
52 opening
54 side wall (54a: inner surface, 54b: outer surface)
56 bottom wall (56a: inner surface, 56b: outer surface)
58 first guide portion (58a: tapered surface)
60 holding portion
62 pressing portion (62a: inner surface, 62b: outer surface)
66 non-pressing portion (66a: inner surface, 66b: outer surface)
67 gap
68 boundary
69 non-holding portion
70 heat insulating portion
80 internal space
90 measuring unit
91 electrically conductive layer
92 first end portion
93 second end portion
94 third electrically insulating layer
95 conducting wire

1. An aerosol generation system comprising a tubular body that accommodates a substrate containing an aerosol source,
resistive heating layers that are laminated onto the outer side of a side wall of the tubular body, and
electrically conductive layers that are laminated so as to overlap at least portions of the resistive heating layers.

2. The aerosol generation system as claimed in claim 1, wherein the rate of variation, with respect to temperature, in the temperature coefficient of resistance of the electrically conductive layers is less than the rate of variation, with respect to temperature, in the temperature coefficient of resistance of the resistive heating layers.

3. The aerosol generation system as claimed in claim 1, wherein the electrically conductive layers are made of a single metal, and the resistive heating layers are made of an alloy.

4. The aerosol generation system as claimed in claim 1, wherein the resistive beating layers have a first part which generates heat when a current flows and a second part which generates less heat than the first part, and
the electrically conductive layers are laminated so as to overlap at least portions of the first parts of the resistive heating layers.

5. The aerosol generation system as claimed in claim 4, wherein conducting wires connected to a power source unit that applies a voltage to the electrically conductive layers are connected to parts of the electrically conductive layers that do not overlap the first part.

6. The aerosol-generating system as claimed in claim 1, wherein the direction in which a current flows in the resistive heating layers and the direction in which a current flows in the parts of the electrically conductive layers that overlap the resistive heating layers coincide.

7. The aerosol-generating system as claimed in claim 1, further comprising a control unit that controls the supply of power to the resistive heating layers on the basis of an electrical resistance value of the electrically conductive layers.

8. The aerosol generation system as claimed in claim 7, wherein the control unit repeats, in the stated order, a first step for applying a voltage to the electrically conductive layers to measure an electrical resistance value of the electrically conductive layers, and a second step for applying a voltage to the resistive heating layers in a manner determined on the basis of the electrical resistance value of the electrically conductive layers measured in the first step.

9. The aerosol generation system as claimed in claim 8, wherein the control unit causes a period during which the first step is performed and a period during which the second step is performed to differ.

10. The aerosol-generating system as claimed in claim 7, wherein the control unit controls the manner in which the voltage is applied to the resistive heating layers on the basis of control information defining a time series transition of a target value of a parameter corresponding to the temperature of the resistive heating layers.

11. The aerosol generation system as claimed in claim 10, wherein the period during which the supply of power to the resistive heating layers is controlled on the basis of the control information includes, in the stated order:
a first period during which the temperature of the resistive heating layers increases from an initial temperature or is maintained;
a second period, following the first period, during which the temperature of the resistive heating layers decreases or is maintained; and
a third period, following the second period, during which the temperature of the resistive heating layers increases or is maintained.

12. The aerosol generation system as claimed in claim 10, wherein the period during which the supply of power to the resistive heating layers is controlled on the basis of the control information includes, in the stated order:
a first period during which the temperature of the resistive heating layers increases from an initial temperature or is maintained;
a second period, following the first period, during which the temperature of the resistive heating layers decreases; and
a third period, following the second period, during which the temperature of the resistive heating layers increases or is maintained.

13. The aerosol-generating system as claimed in claim 1, further comprising the substrate.

14. A control method executed by a computer that controls an aerosol generation system, wherein
the aerosol generation system comprises
a tubular body that accommodates a substrate containing an aerosol source,
resistive heating layers that are laminated onto the outer side of a side wall of the tubular body, and
electrically conductive layers that are laminated so as to overlap at least portions of the resistive heating layers,
wherein
the control method includes
controlling the supply of electric power to the resistive heating layers on the basis of an electrical resistance value of the electrically conductive layers.

15. A non-transitory computer readable medium having a program stored therein, the program executed by a computer that controls an aerosol generation system, wherein
the aerosol generation system comprises
a tubular body that accommodates a substrate containing an aerosol source,
resistive heating layers that are laminated onto the outer side of a side wall of the tubular body, and
electrically conductive layers that are laminated so as to overlap at least portions of the resistive heating layers,
wherein
the program causes the computer to function as
a control unit that controls the supply of electric power to the resistive heating layers on the basis of an electrical resistance value of the electrically conductive layers.
